(19) United States
(12) Patent Application Publication
(10) Pub. No.: US 2006/0169597 A1
(43) Pub. Date: Aug. 3, 2006

(54) Method and composition for polishing a substrate

(75) Inventors: Feng Q. Liu, San Jose, CA (US); Tianbao Du, Santa Clara, CA (US); Alain Duboust, Sunnyvale, CA (US); Wei-Yung Hsu, Santa Clara, CA (US); Robert A. Ewald, Aptos, CA (US); Yuan Tian, San Jose, CA (US); You Wang, Cupertino, CA (US); Stan D. Tsai, Fremont, CA (US)

Correspondence Address: PATTERSON & SHERIDAN, LLP, 3040 POST OAK BOULEVARD, SUITE 1500, HOUSTON, TX, 77056, US

(73) Assignee: APPLIED MATERIALS, INC.

(21) Appl. No.: 11/356,352

(22) Filed: Feb. 15, 2006

Related U.S. Application Data
(63) Continuation-in-part of application No. 11/196,876, filed on Aug. 4, 2005.
Application No. 11/196,876 is a continuation-in-part of application No. 11/123,174, filed on May 6, 2005.
Application No. 11/123,174 is a continuation-in-part of application No. 10/845,754, filed on May 14, 2004.
Application No. 10/845,754 is a continuation-in-part of application No. 10/608,404, filed on Jun. 26, 2003.
Application No. 10/845,754 is a continuation-in-part of application No. 10/456,220, filed on Jun. 6, 2003.
Application No. 10/456,220 is a continuation-in-part of application No. 10/378,097, filed on Feb. 26, 2003.
Application No. 10/456,220 is a continuation-in-part of application No. 10/038,066, filed on Jan. 3, 2002, now Pat. No. 6,811,680.
(60) Provisional application No. 60/729,009, filed on Oct. 21, 2005.
(60) Provisional application No. 60/359,746, filed on Feb. 26, 2002.
(60) Provisional application No. 60/275,874, filed on Mar. 14, 2001.

(51) Int. Cl. B23H 9/00; B23H 7/00

(52) U.S. Cl. 205/680; 205/682; 205/685; 252/79.2

(57) ABSTRACT

Polishing compositions and methods for removing conductive materials from a substrate surface are provided. In one aspect, a composition includes an acid based electrolyte system, a corrosion inhibitor having an azole group, an organic acid salt, a pH adjusting agent to provide a pH between about 2 and about 10, and a solvent, and a solvent. The composition may be used in a conductive material removal process including disposing a substrate having a conductive material layer formed thereon in a process apparatus comprising an electrode, providing the composition between the electrode and substrate, applying a bias between the electrode and the substrate, and removing conductive material from the conductive material layer. The polishing compositions and methods described herein improve the effective removal rate of materials from the substrate surface, such as copper, with a reduction in planarization type defects and yielding a desirable surface finish.

### CROSS-REFERENCE TO RELATED APPLICATIONS

This application claims benefit to U.S. Provisional Patent application Ser. No. 60/729,009, filed on Oct. 21, 2005, and is a continuation-in-part co-pending U.S. patent application Ser. No. 11/196,876, filed Aug. 4, 2005, which application is a continuation-in-part co-pending U.S. patent application Ser. No. 11/123,174, filed May 5, 2005, which application is a continuation-in-part of co-pending U.S. patent application Ser. No. 10/845,754, filed May 14, 2004, which application is a continuation-in-part of co-pending U.S. patent application Ser. No. 10/608,404, filed Jun. 26, 2003, which application is a continuation-in-part of co-pending U.S. patent application Ser. No. 10/456,220, filed Jun. 6, 2003, which application is a continuation-in-part of co-pending U.S. patent application Ser. No. 10/378,097, filed Feb. 26, 2003, which application claims priority to the U.S. Provisional Patent Application Ser. No. 60/359,746, filed on Feb. 26, 2002, and which U.S. patent application Ser. No. 10/378,097 is a continuation-in-part of U.S. patent application Ser. No. 10/038,066, filed Jan. 3, 2002, now U.S. Pat. No. 6,811,680, issued on Nov. 2, 2004, which application claims priority to the U.S. Provisional Patent Application Ser. No. 60/275,874, filed on Mar. 14, 2001, which applications are herein incorporated by reference.

### BACKGROUND OF THE INVENTION

1. Field of the Invention

Embodiments of the present invention relate to compositions and methods for removing a conductive material from a substrate.

2. Background of the Related Art

Reliably producing sub-half micron and smaller features is one of the key technologies for the next generation of very large scale integration (VLSI) and ultra large-scale integration (ULSI) of semiconductor devices. However, as the limits of circuit technology are pushed, the shrinking dimensions of interconnects in VLSI and ULSI technology have placed additional demands on processing capabilities. Reliable formation of interconnects is important to VLSI and ULSI success and to the continued effort to increase circuit density and quality of individual substrates and die.

Multilevel interconnects are formed using sequential material deposition and material removal techniques on a substrate surface to form features therein. As layers of materials are sequentially deposited and removed, the uppermost surface of the substrate may become non-planar across its surface and require planarization prior to further processing. Planarization or “polishing” is a process where material is removed from the surface of the substrate to form a generally even, planar surface. Planarization is useful in removing excess deposited material, removing undesired surface topography, and surface defects, such as surface roughness, agglomerated materials, crystal lattice damage, scratches, and contaminated layers or materials to provide an even surface for subsequent photolithography and other semiconductor processes.

Chemical mechanical planarization, or chemical mechanical polishing (CMP), is a common technique used to planarize substrates. In conventional CMP techniques, a substrate carrier or polishing head is mounted on a carrier assembly and positioned in contact with a polishing article in a CMP apparatus. The carrier assembly provides a controllable pressure to the substrate urging the substrate against the polishing article. The article is moved relative to the substrate by an external driving force. Thus, the CMP apparatus effects polishing or rubbing movement between the surface of the substrate and the polishing article while dispersing a polishing composition to effect both chemical activity and mechanical activity.

However, materials deposited on the surface of a substrate to fill feature definitions formed therein often result in unevenly formed surfaces over feature definitions of variable density. Referring to FIG. 1A, a metal layer 20 is deposited on a substrate 10 to fill wide feature definitions 30, also known as low density feature definitions, or narrow feature definitions 40, also known as and high density feature definitions. Excess material, called overburden, may be formed with a greater thickness 45 over the narrow feature definitions 40 and may have minimal deposition 35 over wide feature definitions 30. Polishing of surfaces with overburden may result in the retention of residues 50 from inadequate metal removal over narrow features. Overpolishing processes to remove such residues 50 may result in excess metal removal over wide feature definitions 30. Excess metal removal can form topographical defects, such as concavities or depressions known as dishing 55, over wide features, as shown in FIG. 1B.

Dishing of features and retention of residues on the substrate surface are undesirable since dishing and residues may detrimentally affect subsequent processing of the substrate. For example, dishing results in a non-planar surface that impairs the ability to print high-resolution lines during subsequent photolithographic steps and detrimentally affects subsequent surface topography of the substrate, which affects device formation and yields. Dishing also detrimentally affects the performance of devices by lowering the conductance and increasing the resistance of the devices, causing device variability and device yield loss. Residues may lead to uneven polishing of subsequent materials, such as barrier layer materials (not shown) disposed between the conductive material and the substrate surface. Post CMP profiles generally show higher dishing on wide trenches than on narrow trenches or dense areas. Uneven polishing will also increase defect formation in devices and reduce substrate yields.

Therefore, there is a need for compositions and methods for removing conductive material from a substrate that minimizes damage to the substrate during planarization.

### SUMMARY OF THE INVENTION

Aspects of the invention provide compositions and methods for removing conductive materials by an electrochemical polishing technique. In one aspect, a composition is provided for removing at least a conductive material from a substrate surface including an acid based electrolyte system, a corrosion inhibitor having an azole group, an organic acid salt, a pH adjusting agent to provide a pH between about 2 and about 10, and a solvent.

In another aspect, the composition is used in a method provided for processing a substrate including disposing a substrate having a conductive material layer formed thereon in a process apparatus comprising a first electrode and a second electrode, wherein the substrate is in electrical contact with the second electrode, providing the composition between the first electrode and the substrate, applying a bias between the first electrode and the second electrode, moving the substrate and the first electrode relative to each other, and removing conductive material from the conductive material layer.

### BRIEF DESCRIPTION OF THE DRAWINGS

So that the manner in which the above recited aspects of the present invention are attained and can be understood in detail, a more particular description of embodiments of the invention, briefly summarized above, may be had by reference to the embodiments thereof which are illustrated in the appended drawings.

It is to be noted, however, that the appended drawings illustrate only typical embodiments of this invention and are therefore not to be considered limiting of its scope, for the invention may admit to other equally effective embodiments.

FIGS. 1A and 1B schematically illustrate the phenomenon of dishing and erosion respectively;

FIG. 2 is a plan view of an electrochemical mechanical planarizing system;

FIG. 3 is a sectional view of one embodiment of a first electrochemical mechanical planarizing (ECMP) station of the system of FIG. 2;

FIG. 4A is a partial sectional view of the first ECMP station through two contact assemblies;

FIGS. 4B-C are sectional views of alternative embodiments of contact assemblies;

FIGS. 4D-E are sectional views of plugs;

FIGS. 5A and 5B are side, exploded and sectional views of one embodiment of a contact assembly;

FIG. 6 is one embodiment of a contact element;

FIG. 7 is a vertical sectional view of another embodiment of an ECMP station; and

FIGS. 8A-8F are schematic cross-sectional views illustrating a polishing process performed on a substrate according to one embodiment.

### DETAILED DESCRIPTION OF THE PREFERRED EMBODIMENT

In general, aspects of the invention provide compositions and methods for removing at least a conductive material from a substrate surface. The invention is described below in reference to a planarizing process for the removal of conductive materials from a substrate surface by an electrochemical mechanical polishing (ECMP) technique.

The words and phrases used herein should be given their ordinary and customary meaning in the art by one skilled in the art unless otherwise further defined. Chemical polishing should be broadly construed and includes, but is not limited to, planarizing a substrate surface using chemical activity. Electropolishing should be broadly construed and includes, but is not limited to, planarizing a substrate by the application of electrochemical activity. Electrochemical mechanical polishing (ECMP) should be broadly construed and includes, but is not limited to, planarizing a substrate by the application of electrochemical activity, mechanical activity, chemical activity, or a combination of electrochemical, chemical, and mechanical activity to remove material from a substrate surface.

Anodic dissolution should be broadly construed and includes, but is not limited to, the application of an anodic bias to a substrate directly or indirectly which results in the removal of conductive material from a substrate surface and into a surrounding polishing composition. Polishing composition should be broadly construed and includes, but is not limited to, a composition that provides ionic conductivity, and thus, electrical conductivity, in a liquid medium, which generally comprises materials known as electrolyte components. The amount of each electrolyte component in polishing compositions can be measured in volume percent or weight percent. Volume percent refers to a percentage based on volume of a desired liquid component divided by the total volume of all of the liquid in the complete solution. A percentage based on weight percent is the weight of the desired component divided by the total weight of all of the liquid components in the complete solution.

### One Apparatus Embodiment

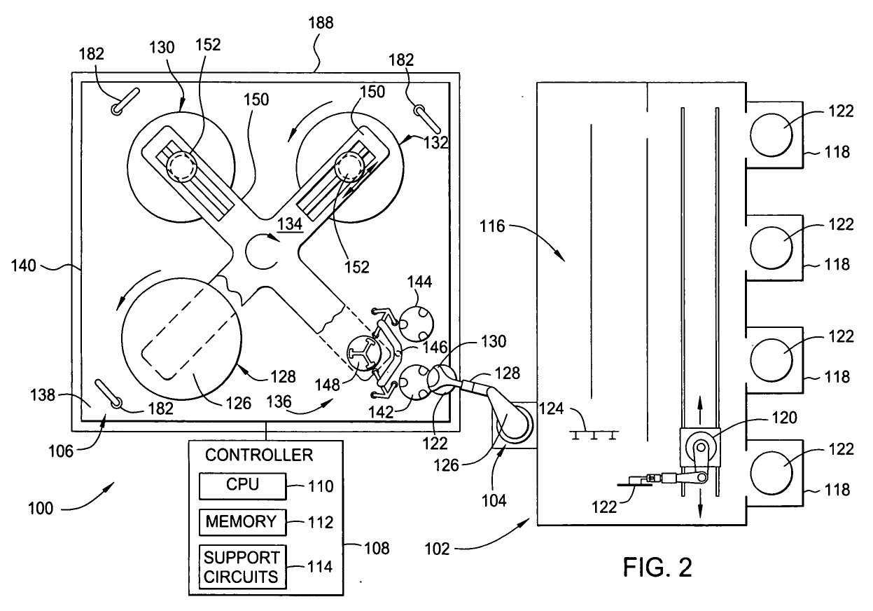

FIG. 2 is a plan view of one embodiment of an exemplary planarization system 100 having an apparatus for electrochemically processing a substrate. The planarization system 100 generally comprises a factory interface 102, a loading robot 104, and a planarizing module 106. The loading robot 104 is disposed proximate the factory interface 102 and the planarizing module 106 to facilitate the transfer of substrates 122 therebetween.

A controller 108 is provided to facilitate control and integration of the modules of the planarization system 100. The controller 108 comprises a central processing unit (CPU) 110, a memory 112, and support circuits 114. The controller 108 is coupled to the various components of the planarization system 100 to facilitate control of, for example, the planarizing, cleaning, and transfer processes.

The factory interface 102 generally includes a cleaning module 116 and a wafer cassette 118. An interface robot 120 is employed to transfer substrate 122 between the wafer cassettes 118, the cleaning module 116 and an input module 124. The input module 124 is positioned to facilitate transfer of substrates 122 between the planarizing module 106 and the factory interface 102 by grippers, for example vacuum grippers or mechanical clamps (not shown).

The planarizing module 106 includes at least a first electrochemical mechanical planarizing (ECMP) station 128, disposed in an environmentally controlled enclosure 188. Examples of planarizing modules 106 that can be adapted to benefit from the invention include MIRRA® Chemical Mechanical Planarizing Systems, MIRRA MESA™ Chemical Mechanical Planarizing Systems, REFLEXION® Chemical Mechanical Planarizing Systems, REFLEXION LK™ Chemical Mechanical Planarizing Systems, and REFLEXION LK ECMP™ Chemical Mechanical Planarizing Systems, all available from Applied Materials, Inc. of Santa Clara, Calif. Other planarizing modules, including those that use processing pads, planarizing webs, or a combination thereof, and those that move a substrate relative to a planarizing surface in a rotational, linear or other planar motion may also be adapted to benefit from the invention.

In the embodiment depicted in FIG. 2, the planarizing module 106 includes one ECMP station 128, a second ECMP station 130 and a third station 132 for CMP. Initial removal of a first portion of the conductive material, bulk material removal, from the substrate is performed through an electrochemical dissolution process at the Ecmp station 128. After the bulk material removal at the Ecmp station 128, removal of a second portion of the conductive material, residual conductive material removal, is performed at the Ecmp station 130 through a second electrochemical mechanical process. It is contemplated that more than one ECMP station 130 for residual removal may be utilized in the planarizing module 106.

A conventional chemical mechanical planarizing process is performed at the planarizing station 132 after processing at the ECMP station 130 by the barrier removal process described herein. Alternatively, an example of a conventional CMP process on a chemical mechanical polishing station for the barrier removal is described in U.S. patent application Ser. No. 10/187,857, filed Jun. 27, 2002, which is incorporated by reference in its entirety. It is contemplated that other CMP processes may be alternatively performed. When the station 132 is a CMP station, which can include conventional CMP designs, further description thereof has been omitted for the sake of brevity.

It is contemplated that more than one ECMP station may be utilized to perform the multi-step removal process after the bulk removal process performed at a different station. Alternatively, each of the first and second ECMP stations 128, 130 may be utilized to perform both the bulk and multi-step conductive material removal on a single station. It is also contemplated that all ECMP stations (for example 3 stations of the module 106 depicted in FIG. 2) may be configured to process the conductive layer with a two step removal process.

The exemplary planarizing module 106 also includes a transfer station 136 and a carousel 134 that are disposed on an upper or first side 138 of a machine base 140. In one embodiment, the transfer station 136 includes an input buffer station 142, an output buffer station 144, a transfer robot 146, and a load cup assembly 148. The input buffer station 142 receives substrates from the factory interface 102 by means of the loading robot 104. The loading robot 104 is also utilized to return polished substrates from the output buffer station 144 to the factory interface 102. The transfer robot 146 is utilized to move substrates between the buffer stations 142, 144 and the load cup assembly 148.

In one embodiment, the transfer robot 146 includes two gripper assemblies (not shown), each having pneumatic gripper fingers that hold the substrate by the substrate's edge. The transfer robot 146 may simultaneously transfer a substrate to be processed from the input buffer station 142 to the load cup assembly 148 while transferring a processed substrate from the load cup assembly 148 to the output buffer station 144. An example of a transfer station that may be used to advantage is described in U.S. Pat. No. 6,156,124, issued Dec. 5, 2000 to Tobin, which is herein incorporated by reference in its entirety.

The carousel 134 is centrally disposed on the base 140. The carousel 134 typically includes a plurality of arms 150, each supporting a planarizing head assembly 152. Two of the arms 150 depicted in FIG. 2 are shown in phantom such that the transfer station 136 and a planarizing surface 126 of the first ECMP station 128 may be seen. The carousel 134 is indexable such that the planarizing head assemblies 152 may be moved between the planarizing stations 128, 130, 132 and the transfer station 136. One carousel that may be utilized to advantage is described in U.S. Pat. No. 5,804,507, issued Sep. 8, 1998 to Perlov, et al., which is hereby incorporated by reference in its entirety.

A conditioning device 182 is disposed on the base 140 adjacent each of the planarizing stations 128, 130, and 132. The conditioning device 182 periodically conditions the planarizing material disposed in the stations 128, 130, 132 to maintain uniform planarizing results.

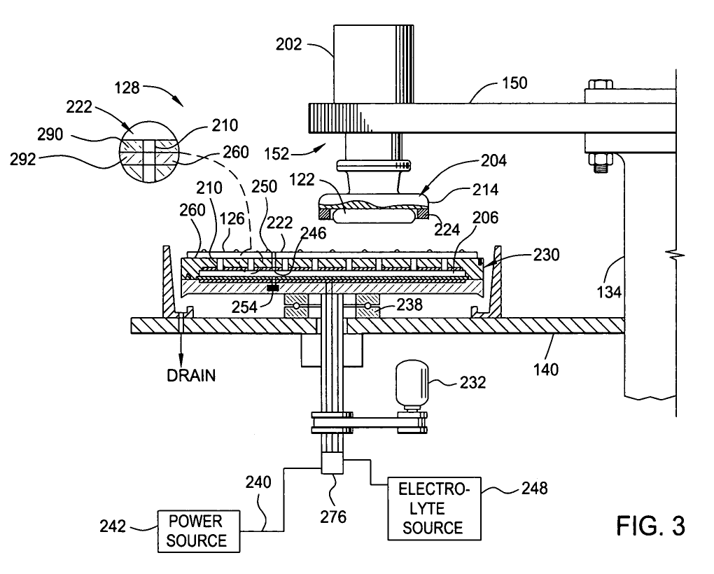

FIG. 3 depicts a sectional view of one of the planarizing head assemblies 152 positioned over one embodiment of the ECMP station 128. The planarizing head assembly 152 generally comprises a drive system 202 coupled to a planarizing head 204. The drive system 202 generally provides at least rotational motion to the planarizing head 204. The planarizing head 204 additionally may be actuated toward the ECMP station 128 such that the substrate 122 retained in the planarizing head 204 may be disposed against the planarizing surface 126 of the ECMP station 128 during processing. The drive system 202 is coupled to the controller 108 that provides a signal to the drive system 202 for controlling the rotational speed and direction of the planarizing head 204.

In one embodiment, the planarizing head may be a TITAN HEAD™ or TITAN PROFILER™ wafer carrier manufactured by Applied Materials, Inc. Generally, the planarizing head 204 comprises a housing 214 and retaining ring 224 that defines a center recess in which the substrate 122 is retained. The retaining ring 224 circumscribes the substrate 122 disposed within the planarizing head 204 to prevent the substrate from slipping out from under the planarizing head 204 while processing. The retaining ring 224 can be made of plastic materials such as polyphenylene sulfide (PPS), polyetheretherketone (PEEK), and the like, or conductive materials such as stainless steel, Cu, Au, Pd, and the like, or some combination thereof. It is further contemplated that a conductive retaining ring 224 may be electrically biased to control the electric field during ECMP. Conductive or biased retaining rings tend to slow the polishing rate proximate the edge of the substrate. It is contemplated that other planarizing heads may be utilized.

The first ECMP station 128 generally includes a platen assembly 230 that is rotationally disposed on the base 140. The platen assembly 230 is supported above the base 140 by a bearing 238 so that the platen assembly 230 may be rotated relative to the base 140. An area of the base 140 circumscribed by the bearing 238 is open and provides a conduit for the electrical, mechanical, pneumatic, control signals and connections communicating with the platen assembly 230.

Conventional bearings, rotary unions and slip rings, collectively referred to as rotary coupler 276, are provided such that electrical, mechanical, fluid, pneumatic, control signals and connections may be coupled between the base 140 and the rotating platen assembly 230. The platen assembly 230 is typically coupled to a motor 232 that provides the rotational motion to the platen assembly 230. The motor 232 is coupled to the controller 108 that provides a signal for controlling for the rotational speed and direction of the platen assembly 230.

A top surface 260 of the platen assembly 230 supports a polishing article assembly 222 thereon. The polishing article assembly may be retained to the platen assembly 230 by magnetic attraction, vacuum, clamps, adhesives and the like.

A plenum 206 is defined in the platen assembly 230 to facilitate uniform distribution of electrolyte to the planarizing surface 126. A plurality of passages, described in greater detail below, are formed in the platen assembly 230 to allow electrolyte, provided to the plenum 206 from an electrolyte source 248, to flow uniformly though the platen assembly 230 and into contact with the substrate 122 during processing. It is contemplated that different electrolyte compositions may be provided during different stages of processing.

The polishing article assembly 222 includes an electrode 292 and at least a planarizing layer 290. The electrode 292 is typically comprised of a conductive material, such as stainless steel, copper, aluminum, gold, silver and tungsten, among others. The electrode 292 may be solid, impermeable to electrolyte, permeable to electrolyte or perforated. At least one contact assembly 250 extends above the polishing article assembly 222 and is adapted to electrically couple the substrate being processed on the polishing article assembly 222 to the power source 242. The electrode 292 is also coupled to the power source 242 so that an electrical potential may be established between the substrate and electrode 292.

A meter (not shown) is provided to detect a metric indicative of the electrochemical process. The meter may be coupled or positioned between the power source 242 and at least one of the electrode 292 or contact assembly 250. The meter may also be integral to the power source 242. In one embodiment, the meter is configured to provide the controller 108 with a metric indicative of processing, such a charge, current and/or voltage. This metric may be utilized by the controller 108 to adjust the processing parameters in-situ or to facilitate endpoint or other process stage detection.

A window 246 is provided through the polishing article assembly 222 and/or platen assembly 230, and is configured to allow a sensor 254, positioned below the polishing article assembly 222, to sense a metric indicative of polishing performance. For example, the sensor 704 may be an eddy current sensor or an interferometer, among other sensors. The metric, provided by the sensor 254 to the controller 108, provides information that may be utilized for processing profile adjustment in-situ, endpoint detection or detection of another point in the electrochemical process. In one embodiment, the sensor 254 an interferometer capable of generating a collimated light beam, which during processing, is directed at and impinges on a side of the substrate 122 that is being polished. The interference between reflected signals is indicative of the thickness of the conductive layer of material being processed. One sensor that may be utilized to advantage is described in U.S. Pat. No. 5,893,796, issued Apr. 13, 1999, to Birang, et al., which is hereby incorporated by reference in its entirety.

Embodiments of the polishing article assembly 222 suitable for removal of conductive material from the substrate 122 may generally include a planarizing surface 126 that is substantially dielectric. Other embodiments of the polishing article assembly 222 suitable for removal of conductive material from the substrate 122 may generally include a planarizing surface 126 that is substantially conductive. At least one contact assembly 250 is provided to couple the substrate to the power source 242 so that the substrate may be biased relative to the electrode 292 during processing. Apertures 210, formed through the planarizing layer 290 and the electrode 292 and the any elements disposed below the electrode, allow the electrolyte to establish a conductive path between the substrate 122 and electrode 292.

In one embodiment, the planarizing layer 290 of the polishing article assembly 222 is a dielectric, such as polyurethane. Examples of polishing article assemblies that may be adapted to benefit from the invention are described in U.S. patent application Ser. No. 10/455,941, filed Jun. 6, 2003, entitled “Conductive Planarizing Article For Electrochemical Mechanical Planarizing”, and U.S. patent application Ser. No. 10/455,895, filed Jun. 6, 2003, entitled “Conductive Planarizing Article For Electrochemical Mechanical Planarizing,” both of which are hereby incorporated by reference in their entireties.

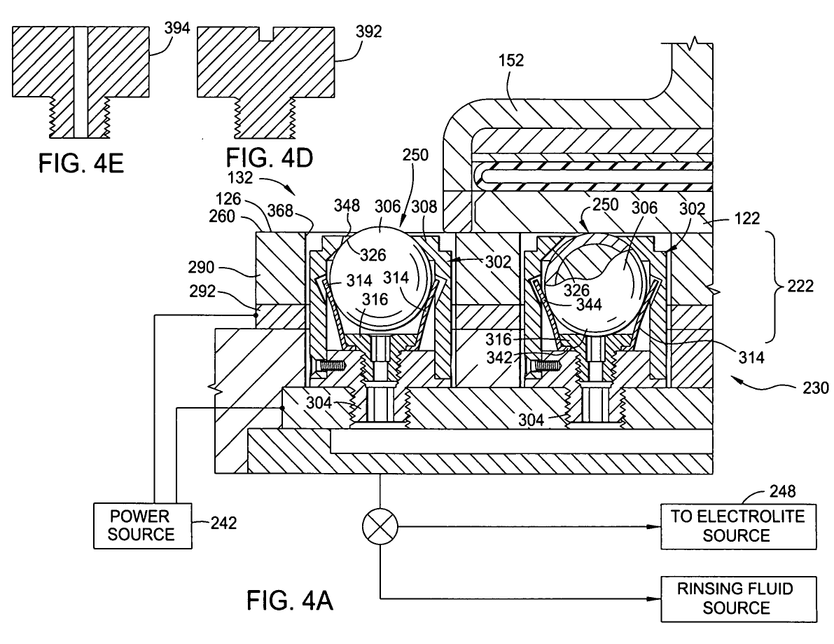

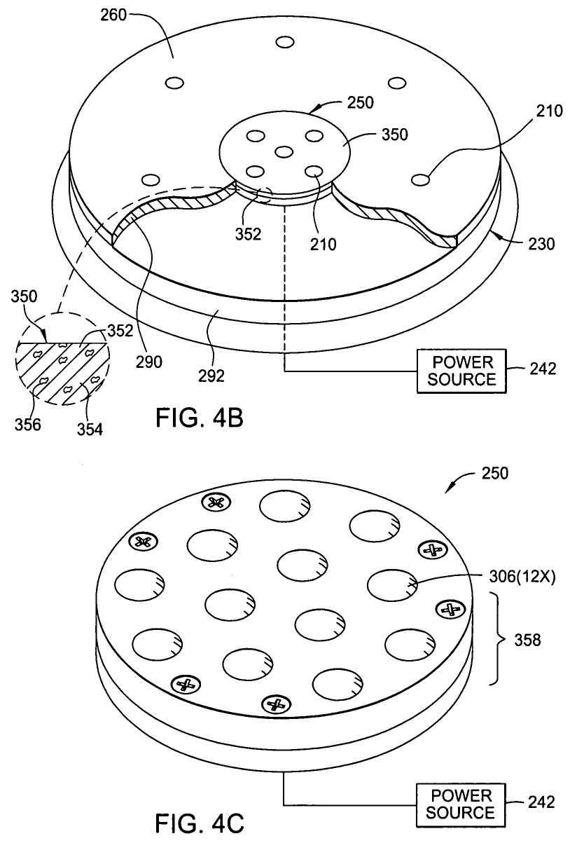

FIG. 4A is a partial sectional view of the first ECMP station 128 through two contact assemblies 250, and FIGS. 5A-C are side, exploded and sectional views of one of the contact assemblies 250 shown in FIG. 5A. The platen assembly 230 includes at least one contact assembly 250 projecting therefrom and coupled to the power source 242 that is adapted to bias a surface of the substrate 122 during processing. The contact assemblies 250 may be coupled to the platen assembly 230, part of the polishing article assembly 222, or a separate element. Although two contact assemblies 250 are shown in FIG. 3A, any number of contact assemblies may be utilized and may be distributed in any number of configurations relative to the centerline of the platen assembly 230.

The contact assemblies 250 are generally electrically coupled to the power source 242 through the platen assembly 230 and are movable to extend at least partially through respective apertures 368 formed in the polishing article assembly 222. The positions of the contact assemblies 250 may be chosen to have a predetermined configuration across the platen assembly 230. For predefined processes, individual contact assemblies 250 may be repositioned in different apertures 368, while apertures not containing contact assemblies may be plugged with a stopper 392 or filled with a nozzle 394 (as shown in FIGS. 4D-E) that allows flow of electrolyte from the plenum 206 to the substrate. One contact assembly that may be adapted to benefit from the invention is described in U.S. patent application Ser. No. 10/445,239, filed May 23, 2003, by Butterfield, et al., and is hereby incorporated by reference in its entirety.

Although the embodiments of the contact assembly 250 described below with respect to FIG. 4A depicts a rolling ball contact, the contact assembly 250 may alternatively comprise a structure or assembly having a conductive upper layer or surface suitable for electrically biasing the substrate 122 during processing. For example, as depicted in FIG. 4B, the contact assembly 250 may include an article structure 350 having an upper layer 352 made from a conductive material or a conductive composite (i.e., the conductive elements are dispersed integrally with or comprise the material comprising the upper surface), such as a polymer matrix 354 having conductive particles 356 dispersed therein or a conductive coated fabric, among others. The article structure 350 may include an of the apertures 210 formed therethrough for electrolyte delivery to the upper surface of the article assembly. Other examples of suitable contact assemblies are described in U.S. Provisional Patent Application Ser. No. 60/516,680, filed Nov. 3, 2003, by Hu, et al., which is hereby incorporated by reference in its entirety.

In one embodiment, each of the contact assemblies 250 includes a hollow housing 302, an adapter 304, a ball 306, a contact element 314 and a clamp bushing 316. The ball 306 has a conductive outer surface and is movably disposed in the housing 302. The ball 306 may be disposed in a first position having at least a portion of the ball 306 extending above the planarizing surface 126 and at least a second position where the ball 306 is substantially flush with the planarizing surface 126. It is also contemplated that the ball 306 may move completely below the planarizing surface 126. The ball 306 is generally suitable for electrically coupling the substrate 122 to the power source 242. It is contemplated that a plurality of balls 306 for biasing the substrate may be disposed in a single housing 358 as depicted in FIG. 4C.

The power source 242 generally provides a positive electrical bias to the ball 306 during processing. Between planarizing substrates, the power source 242 may optionally apply a negative bias to the ball 306 to minimize attack on the ball 306 by process chemistries.

The housing 302 is configured to provide a conduit for the flow of electrolyte from the source 248 to the substrate 122 during processing. The housing 302 is fabricated from a dielectric material compatible with process chemistries. A seat 326 formed in the housing 302 prevents the ball 306 from passing out of the first end 308 of the housing 302. The seat 326 optionally may include a grooves 348 formed therein that allow fluid flow to exit the housing 302 between the ball 306 and seat 326. Maintaining fluid flow past the ball 306 may minimize the propensity of process chemistries to attack the ball 306.

The contact element 314 is coupled between the clamp bushing 316 and the adapter 304. The contact element 314 is generally configured to electrically connect the adapter 304 and ball 306 substantially or completely through the range of ball positions within the housing 302. In one embodiment, the contact element 314 may be configured as a spring form.

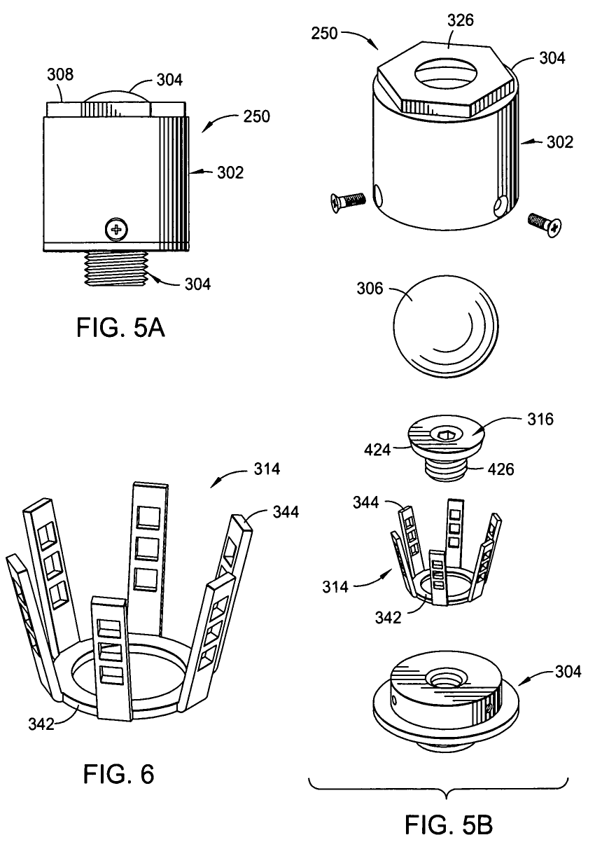

In the embodiment depicted in FIGS. 4A-E and 5A-C and detailed in FIG. 6, the contact element 314 includes an annular base 342 having a plurality of flexures 344 extending therefrom in a polar array. The flexure 344 is generally fabricated from a resilient and conductive material suitable for use with process chemistries. In one embodiment, the flexure 344 is fabricated from gold plated beryllium copper.

Returning to FIGS. 4An and 5A-B, the clamp bushing 316 includes a flared head 424 having a threaded post 422 extending therefrom. The clamp bushing 316 may be fabricated from either a dielectric or conductive material, or a combination thereof, and in one embodiment, is fabricated from the same material as the housing 302. The flared head 424 maintains the flexures 344 at an acute angle relative to the centerline of the contact assembly 250 so that the flexures 344 of the contact elements 314 are positioned to spread around the surface of the ball 306 to prevent bending, binding and/or damage to the flexures 344 during assembly of the contact assembly 250 and through the range of motion of the ball 306.

The ball 306 may be solid or hollow and is typically fabricated from a conductive material. For example, the ball 306 may be fabricated from a metal, conductive polymer or a polymeric material filled with conductive material, such as metals, conductive carbon or graphite, among other conductive materials. Alternatively, the ball 306 may be formed from a solid or hollow core that is coated with a conductive material. The core may be non-conductive and at least partially coated with a conductive covering.

The ball 306 is generally actuated toward the planarizing surface 126 by at least one of spring, buoyant or flow forces. In the embodiment depicted in FIG. 5, flow through the passages formed through the adapter 304 and clamp bushing 316 and the platen assembly 230 from the electrolyte source 248 urge the ball 306 into contact with the substrate during processing.

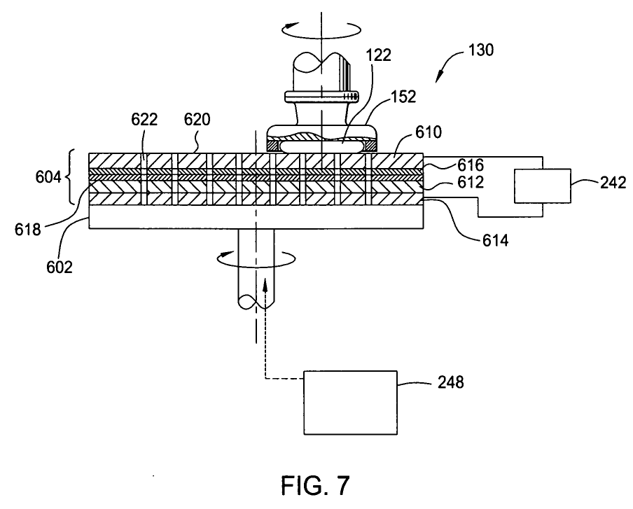

FIG. 7 is a sectional view of one embodiment of the second ECMP station 130. The first and third ECMP stations 128, 132 may be configured similarly. The second ECMP station 130 generally includes a platen 602 that supports a fully conductive polishing article assembly 604. The platen 602 may be configured similar to the platen assembly 230 described above to deliver electrolyte through the polishing article assembly 604, or the platen 602 may have a fluid delivery arm (not shown) disposed adjacent thereto configured to supply electrolyte to a planarizing surface of the polishing article assembly 604. The platen assembly 602 includes at least one of a meter or sensor 254 (shown in FIG. 3) to facilitate endpoint detection.

In one embodiment, the polishing article assembly 604 includes interposed article 612 sandwiched between a conductive polishing article 610 and an electrode 614. The conductive polishing article 610 is substantially conductive across its top processing surface and is generally made from a conductive material or a conductive composite (i.e., the conductive elements are dispersed integrally with or comprise the material comprising the planarizing surface), such as a polymer matrix having conductive particles dispersed therein or a conductive coated fabric, among others. The conductive polishing article 610, the interposed article 612, and the electrode 614 may be fabricated into a single, replaceable assembly. The polishing article assembly 604 is generally permeable or perforated to allow electrolyte to pass between the electrode 614 and top surface 620 of the conductive polishing article 610. In the embodiment depicted in FIG. 7, the polishing article assembly 604 is perforated by apertures 622 to allow electrolyte to flow therethrough. In one embodiment, the conductive polishing article 610 is comprised of a conductive material disposed on a polymer matrix disposed on a conductive fiber, for example, tin particles in a polymer matrix disposed on a woven copper coated polymer. The conductive polishing article 610 may also be utilized for the contact assembly 250 in the embodiment of FIG. 3. In an alternative embodiment, the polishing article may comprise a conventional polishing material, such as polyurethane, for example in an IC-1010 pad from Rodel, Inc, of Phoenix, Ariz.

A conductive foil 616 may additionally be disposed between the conductive polishing article 610 and the interposed article (subpad) 612. The foil 616 is coupled to a power source 242 and provides uniform distribution of voltage applied by the source 242 across the conductive polishing article 610. In embodiments not including the conductive foil 616, the conductive polishing article 610 may be coupled directly, for example, via a terminal integral to the article 610, to the power source 242. Additionally, the article assembly 604 may include an interposed article 618, which, along with the foil 616, provides mechanical strength to the overlying conductive polishing article 610. Examples of suitable article assemblies are described in the previously incorporated U.S. patent application Ser. Nos. 10/455,941 and 10/455,895.

The process cell 200 may be disposed on a polishing platform, for example, the Reflexion LK Ecmp™ System, which is commercially available from Applied Materials, Inc., of Santa Clara, Calif. Additionally, any system enabling electrochemical mechanical polishing using the method or composition described herein can be used to advantage.

Polishing Process

Methods are provided for polishing a substrate to remove a conductive material and/or a barrier material with minimal formation of topographical defects, such as dishing within features, and minimal formation of residual material. The methods may be performed by an electrochemical polishing technique, which includes a combination of chemical activity, mechanical activity and electrical activity to remove conductive materials and planarize a substrate surface. The polishing compositions described herein form passivation layers on the substrate surface and may be used to form protrusion in deposited material after one or more polishing steps. The passivation layer may chemically and/or electrically insulate material disposed on a substrate surface.

In one embodiment of the polishing process, a first polishing step is performed to remove a first portion of the conductive material, bulk conductive material, and form a protrusion over wide feature definitions and a second polishing step is performed to remove a second portion of the conductive material including the protrusion and any residual conductive material, to planarize the conductive material to the barrier layer. The process may also include removing a portion or all of a barrier layer in the second polishing step. In another embodiment of the polishing process, a first polishing step is performed to remove the first portion of the conductive material, bulk conductive material, to the barrier layer and form a protrusion over wide feature definitions and a second polishing step is performed to remove the second portion of the conductive materials including protrusion and any residual conductive material, and the barrier layer. The processes may be performed by electrochemical mechanical polishing (Ecmp) techniques.

The first portion of conductive material, bulk removal, electrochemical mechanical polishing process may be performed on a first polishing platen and the second portion of conductive material, residual, removal electrochemical mechanical polishing process on a second polishing platen of the same or different polishing apparatus as the first platen. In another embodiment of the two-step process, the residual removal electrochemical mechanical polishing process may be performed on the same platen with the bulk removal process. Any barrier material may be removed on a separate platen, such as the third platen in the apparatus described in FIG. 2. For example, the apparatus described above in accordance with the processes described herein may include three platens for removing conductive material, such as copper or tungsten materials, including, for example, a first platen to remove bulk material, a second platen for residual removal and a third platen for barrier removal and/or buffing the substrate surface. In such an apparatus, the bulk and the residual processes are electrochemical mechanical polishing processes and the barrier removal is a CMP process or another electrochemical mechanical polishing process. In another embodiment, three electrochemical mechanical polishing platens may be used to remove bulk material, residual removal and barrier removal.

Bulk material is broadly defined herein as any material deposited on the substrate in an amount more than sufficient to substantially fill features formed on the substrate surface. Residual material, or residue material, is broadly defined as any bulk material remaining after one or more polishing process steps. Generally, the bulk removal during a first Ecmp process removes at least about 50% of the conductive layer, preferably at least about 70%, more preferably at least about 80%, for example, at least about 90%. The residual removal during a second Ecmp process removes most, if not all the remaining conductive material disposed on the barrier layer to leave behind the filled plugs.

The terms wide and narrow feature definitions are relative to device size, for example, wide feature definitions are currently considered to be greater than about 2 μm in width or size and narrow feature definitions are considered to be less than or equal to about 2 μm. The invention contemplates the processes described herein being applied to the relative wide and narrow feature definitions for various device sizes. Also the invention contemplates the processes described herein to be used to polish the relative wide and narrow feature definitions for devices that exhibit the removal rate profiles, e.g., chemical mechanical polishing processes having higher removal rates over wide features as compared to narrow features, as described herein, to form the protrusion as described herein.

While the following processes and compositions are described for removing copper-containing materials, the invention contemplates that the compositions and processes herein also may be used for the removal of other conductive materials, for example, materials containing aluminum, platinum, tungsten, titanium, titanium nitride, tantalum, tantalum nitride, cobalt, gold, silver, ruthenium and combinations thereof, among others.

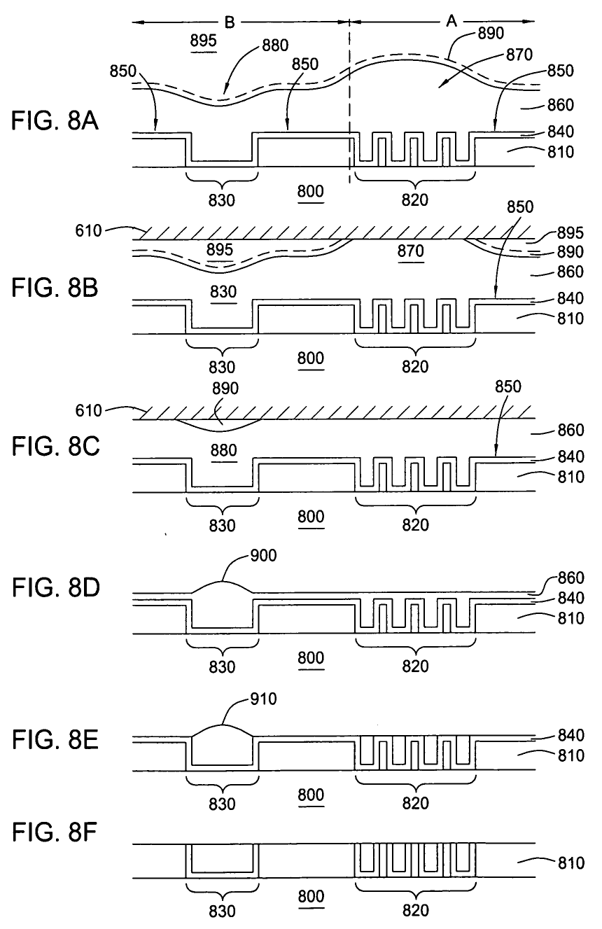

One embodiment of the two-step process will now be described in reference to FIGS. 8A-8F, which are schematic cross-sections views of substrate being formed according to processes described herein with a protrusion being formed in a first processing step and planarizing a substrate surface described herein. A first electrochemical mechanical polishing process may be used to remove a first portion of the conductive material, bulk conductive material, from the substrate surface as shown from FIGS. 8A-8D and then a second electrochemical mechanical polishing process to remove a second portion of conductive material, residual conductive material, as shown from FIGS. 8D-8E. Subsequent processes, such as barrier removal and buffering are used to produce the structure shown in FIG. 8E-8F. The first electrochemical mechanical polishing process produces to a fast removal rate of the copper layer and the second electrochemical mechanical polishing process, due to the precise removal of the remaining copper material, and forms level substrate surfaces with reduced or minimal dishing and erosion of substrate features.

FIG. 8A is a schematic cross-sectional view illustrating one embodiment of a first electrochemical mechanical polishing process for removal of bulk conductive material, such as copper or tungsten. The substrate is disposed in an apparatus containing a first electrode. The substrate 800 has a dielectric layer 810 patterned with narrow feature definitions 820 and wide feature definitions 830. Narrow feature definitions 820 and wide feature definitions 830 have a barrier layer 840, for example, titanium and/or titanium nitride, or alternatively, tantalum and/or tantalum nitride, deposited therein followed by a fill of a conductive material 860, for example, copper. The deposition profile of the excess material includes a high overburden 870, also referred to as a hill or peak, formed over narrow feature definitions 820 and a minimal overburden 880, also referred to as a valley, formed over wide feature definitions 830.

The terms narrow and wide feature definitions may vary depending on the structures formed on the substrate surface, but can generally be characterized by the respective deposition profiles of excessive material deposition (or high overburden) formed over narrow feature definitions and minimal or low material deposition (minimal or low overburden), over wide feature definitions. For example narrow feature definitions may be less than 1 μm in size and may have a high overburden as compared to wide feature definitions that may be about 2 μm or greater in size and that may have minimal or insufficient overburden. However, high overburdens and low overburdens do not necessarily have to form over features, but may form over areas on the substrate surface between features.

The dielectric layer 810 may comprise a dielectric materials conventionally employed in the manufacture of semiconductor devices. For example, dielectric materials may include materials such as silicon dioxide, phosphorus-doped silicon glass (PSG), boron-phosphorus-doped silicon glass (BPSG), and silicon dioxide derived from tetraethyl orthosilicate (TEOS) or silane by plasma enhanced chemical vapor deposition (PECVD). The dielectric layer may also comprise low dielectric constant materials, including fluoro-silicon glass (FSG), polymers, such as polyamides, carbon-containing silicon oxides, such as Black Diamond™ dielectric material, silicon carbide materials, which may be doped with nitrogen and/or oxygen, including BLOK™ dielectric materials, available from Applied Materials, Inc. of Santa Clara, Calif.

A barrier layer 840 is disposed conformally in the feature definitions 820 and 830 and on the substrate 800. The barrier layer 840 may comprise metals or metal nitrides, such as tantalum, tantalum nitride, tantalum silicon nitride, titanium, titanium nitride, titanium silicon nitride, tungsten, tungsten nitride and combinations thereof, or any other material that may limit diffusion of materials between the substrate and/or dielectric materials and any subsequently deposited conductive materials.

A conductive material 860 is disposed on the barrier layer 840. The term “conductive material layer” as used herein is defined as any conductive material, such as copper, tungsten, aluminum, and/or their alloys used to fill a feature to form lines, contacts or vias. While not shown, a seed layer of a conductive material may be deposited on the barrier layer prior to the deposition of the conductive material 860 to improve interlayer adhesion and improve subsequent deposition processes. The seed layer may be of the same material as the subsequent material to be deposited.

One type of conductive material 860 comprises copper containing materials. Copper containing materials include copper, copper alloys (e.g., copper-based alloys containing at least about 80 weight percent copper) or doped copper. As used throughout this disclosure, the phrase “copper containing material,” the word “copper,” and the symbol “Cu” are intended to encompass copper, copper alloys, doped copper, and combinations thereof. Additionally, the conductive material may comprise any conductive material used in semiconductor manufacturing processing.

The substrate may then be positioned in a polishing apparatus, such as the apparatus descried herein and shown in FIG. 2, and exposed to a polishing composition that can form a passivation layer 890 on the conductive material layer. In the first electrochemical mechanical polishing step, the passivation layer 890 is formed from exposure of the conductive material to the bulk polishing composition described herein. The passivation layer 890 forms on the exposed conductive material 860 on the substrate surface including the high overburden 870, peaks, and minimal overburden 880, valleys, formed in the deposited conductive material 860. The passivation layer 890 chemically and/or electrically insulates the surface of the substrate from chemical and/or electrical reactions.

An electrochemical mechanical polishing technique using a combination of chemical activity, mechanical activity, and electrical activity to remove material and planarize a substrate surface may be performed as follows. In one embodiment of an electrochemical mechanical polishing technique, the substrate is disposed in a carrier head system, as shown in FIG. 2, and physically contacted with a polishing article coupled to a polishing assembly containing first and second electrodes. Relative motion is provided between the substrate surface and the conductive polishing article 610 to reduce or remove the passivation layer. A bias from a power source 242 is applied between the two electrodes and the substrate and polishing article are then electrically coupled with the substrate through the polishing article coupled to the first electrode. The bias may be applied by an electrical pulse modulation technique providing at least anodic dissolution. The bias may be transferred from a conductive polishing article 610 in the polishing article assembly 222 to the substrate 208. During the physical and electrical coupling of the substrate and the polishing article, a polishing composition is provided therebetween to form the passivation layer 890 on the substrate surface.

The process begins with a substrate being positioned in a polishing apparatus, such as the apparatus descried herein and shown in FIG. 3. A first, or bulk removal, polishing composition as described herein is provided to the substrate surface. The first polishing composition may be provided at a flow rate between about 50 and about 800 milliliters per minute, such as about 300 milliliters per minute, to the substrate surface. The conductive material exposed to a polishing composition results in the formation of the passivation layer 890 on the conductive material 860.

An example of the first polishing composition for the bulk removal step includes about 12 wt. % potassium phosphate monobasic, about 1% by volume ethylenediamine, about 2% by weight ammonium citrate tribasic, about 0.3% by weight benzotriazole, between about 0.5 vol. % and about 6 vol. % potassium hydroxide to provide a pH of about 5, and deionized water. The process may also be performed with a composition temperature between about 20° C. and about 60° C.

The passivation layer is formed from the exposure of the substrate surface to the corrosion inhibitor and/or other materials capable of forming a passivating or insulating film, for example, chelating agents. The thickness and density of the passivation layer can dictate the extent of chemical reactions and/or amount of anodic dissolution. For example, a thicker or denser passivation layer 890 has been observed to result in less anodic dissolution compared to thinner and less dense passivation layers. Thus, control of the composition and concentration of passivating agents, corrosion inhibitors and/or chelating agents, allows for customized removal rates and amounts of material removed from the substrate surface.

The substrate surface and a polishing article, such as conductive polishing article 610, are contacted with one another and moved in relative motion to one another, such as in a relative orbital motion, to remove portions of the passivation layer 890 formed on the exposed conductive material 860 as shown in FIG. 8B, which may also remove a portion of the underlying conductive material 860. The first conductive material polishing step, an electrochemical mechanical polishing step, is performed for FIGS. 8A-8D as follows to form the protrusion 900.

A polishing article coupled to a polishing article assembly containing a second electrode is then physically contacted and/or electrically coupled with the substrate through a conductive polishing article. The substrate surface and polishing article are contacted at a pressure less than about 2 pounds per square inch (lb/in² or psi) (13.8 kPa). The contact pressure may include a pressure of about 1 psi (6.9 kPa) or less, for example, between about 0.01 psi (69 Pa) and about 1 psi (6.9 kPa), such as between about 0.1 (0.7 kPa) psi and about 0.8 psi (5.5 kPa) or between about 0.1 (0.7 kPa) psi and about 0.5 psi (3.4 kPa). In one aspect of the process, a pressure of about 0.3 psi (2.1 kPa) or about 0.2 psi (1.4 kPa) may be used during a processing step.

Relative motion is provided between the substrate surface and the conductive polishing article 203 to reduce or remove the passivation layer 890. Relative motion is provided between the substrate surface and a conductive polishing article disposed in the polishing article assembly 222. The conductive polishing article assembly 222 disposed on the platen is rotated at a platen rotational rate of between about 4 rpm and about 80 rpm, such as between about 5 rpm and about 40 rpm, for example, about 28 rpm, and the substrate disposed in a carrier head is rotated at a carrier head rotational rate between about 5 rpm and about 80 rpm, such as between about 6 rpm and about 50 rpm, for example, about 37 rpm. The respective rotational rates of the platen and carrier head are believed to provide reduced shear forces and frictional forces when contacting the polishing article and substrate.

In one aspect of bulk polishing process, the carrier head rotational speed may be greater than a platen rotational speed by a ratio of carrier head rotational speed to platen rotational speed of greater than about 1:1, such as a ratio of carrier head rotational speed to platen rotational speed between about 1.2:1 and about 12:1, for example between about 1.5:1 and about 3:1, to remove material from the substrate surface.

A combination of contact and relative motion between the substrate and the polishing article provided mechanical abrasion that may allow a region of non-passivated conductive material to be removed and/or exposed to a bias for removal by anodic dissolution.

A bias is applied to the substrate during contact between the substrate surface and the conductive polishing article 610 for anodic dissolution of the conductive material 860 from the substrate surface. The bias is provided from a power source 242 is applied between the two electrodes. The bias may be transferred from a conductive polishing article and/or electrode in the polishing article assembly 222 to the substrate 208. The bias may be applied by an electrical pulse modulation technique providing at least anodic dissolution.

The bias for the bulk removal step is generally provided to produce anodic dissolution of the conductive material from the surface of the substrate at a current density between about 0.001 milliamps/centimeter (mA/cm²) and about 100 mA/cm² which correlates to an applied current of up to about 40 amps to process substrates with a diameter up and about 300 mm. For example, a 200 mm diameter substrate may have a current density between about 0.01 mA/cm² and about 50 mA/cm², which correlates to an applied current between about 0.01 A and about 20 A. The invention also contemplates that the bias may be applied and monitored by volts, amps and watts. For example, in one embodiment, the power supply may apply a power between about 0.01 watts and 100 watts, a voltage between about 0.01 V and about 10 V, and a current between about 0.01 amps and about 10 amps. The bias between about 2.6 volts and about 3.5 volts, such as 3 volts, may be used as the applied bias in the first electrochemical processing step.

One examples of a bias application process for the first and second Ecmp steps is further described in U.S. patent application Ser. No. __/______, filed on Feb. ______, 2006, entitled “Method For Electrochemically Polishing A Conductive Material On A Substrate” [Attorney Docket Number 010312/PPC/CMP/CKIM], which application is incorporated herein to the extent not inconsistent with the claims aspects and description herein.

During anodic dissolution under application of the bias, the substrate surface, which includes the conductive material 860, may be biased anodically above a threshold potential of the conductive material, for example, a metal material, on the substrate surface to “oxidize”. When a metal material oxidizes, a metal atom gives up one or more electrons to the power source 242 and forms metal ions or cations. The metal ions may then leave the substrate surface and dissolve into the electrolyte solution. In the case where copper is the desired material to be removed, cations can have the Cu¹⁺ or Cu²⁺ oxidation state.

The metal ions may also contribute to the formation of the thickness and/or density of the passivation layer 890. For example, the inhibitors and/or chelating agents found in the polishing composition may complex with the metal ions and the metal ions become incorporated into the passivation layer 890. Thus, the presence of the inhibitors and/or chelating agents found in the polishing composition limit or reduce the electrochemical dissolution process of the metal ions into the electrolyte, and further incorporate such metal ions into the passivation layer 890.

It has been observed that the thickness and/or density of the undisturbed passivation layer may increase after periods of applied bias for anodic dissolution of conductive materials on the substrate surface. It is believed that the increase in the thickness and/or density of the undisturbed passivation layer is related to the total applied power and is a function of time and/or power levels. The thickness and density of the passivation layer can dictate the extent of chemical reactions and/or amount of anodic dissolution. For example, a thicker or denser passivation layer 890 has been observed to result in less anodic dissolution compared to thinner and less dense passivation layers. Thus, control of the composition of passivating agents, corrosion inhibitors and/or chelating agents, allow control of the removal rate and amount of material removed from the substrate surface.

The bias may be varied in power and application depending upon the user requirements in removing material from the substrate surface. For example, increasing power application has been observed to result in increasing anodic dissolution. The bias may also be applied by an electrical pulse modulation technique. Pulse modulation techniques may vary, but generally include a cycle of applying a constant current density or voltage for a first time period, then applying no current density or voltage or a constant reverse current density or voltage for a second time period. The process may then be repeated for one or more cycles, which may have varying power levels and durations. The power levels, the duration of power, an “on” cycle, and no power, an “off cycle” application, and frequency of cycles, may be modified based on the removal rate, materials to be removed, and the extent of the polishing process. For example, increased power levels and increased duration of power being applied have been observed to increase anodic dissolution.

In one pulse modulation process for electrochemical mechanical polishing, the pulse modulation process comprises an on/off power technique with a period of power application, “on,” followed by a period of no power application, “off”. The on/off cycle may be repeated one or more times during the polishing process. The “on” periods allow for removal of exposed conductive material from the substrate surface and the “off” periods allow for polishing composition components and by-products of “on” periods, such as metal ions, to diffuse to the surface and complex with the conductive material. During a pulse modulation technique process it is believed that the metal ions migrate and interact with the corrosion inhibitors and/or chelating agents by attaching to the passivation layer in the non-mechanically disturbed areas. The process thus allows etching in the electrochemically active regions, not covered by the passivation layer, during an “on” application, and then allowing reformation of the passivation layer in some regions and removal of excess material during an “off” portion of the pulse modulation technique in other regions. Thus, control of the pulse modulation technique can control the removal rate and amount of material removed from the substrate surface.

The “on”/“off” period of time may be between about 0.1 seconds and about 60 seconds each, for example, between about 2 and about 25 seconds, and the invention contemplates the use of pulse techniques having “on” and “off” periods of time greater and shorter than the described time periods herein. In one example of a pulse modulation technique, power is applied between about 40% and about 98% of each cycle.

Non-limiting examples of pulse modulation technique with an on/off cycle for electrochemical mechanical polishing of materials described herein include: applying power, “on,” between about 5 and about 10 seconds and then not applying power, “off,” between about 2 and about 25 seconds; applying power for about 10 seconds and not applying power for 5 seconds, or applying power for 10 seconds and not applying power for 2 seconds, or even applying power for 5 seconds and not applying power for 25 seconds to provide the desired polishing results. The cycles may be repeated as often as desired for each selected process. One example of a pulse modulation process is described in U.S. Pat. No. 6,379,223, entitled “Method and Apparatus for Electrochemical Mechanical Planarization,” issued on Apr. 22, 2002, which is incorporated by reference herein to the extent not inconsistent with the claimed aspects and disclosure herein. Further examples of a pulse modulation process is described in co-pending U.S. patent application Ser. No. 10/611,805, entitled “Effective Method To Improve Surface Finish In Electrochemically Assisted Chemical Mechanical Polishing,” filed on Jun. 30, 2003, which is incorporated by reference herein to the extent not inconsistent with the claimed aspects and disclosure herein.

Mechanical abrasion by a conductive polishing article removes the passivation layer 890 that insulates the conductive material chemically and/or electrically. For example, the passivation layer suppresses the current for anodic dissolution so that areas of high overburden is preferentially removed over areas of minimal overburden as the passivation layer is retained in areas of minimal or no contact with the conductive polishing article 203. The removal rate of the conductive material 860 covered by the passivation layer 890 is less than the removal rate of conductive material without the passivation layer 890. As such, the excess material disposed over narrow feature definitions 820 and the substrate field 850 is removed at a higher rate than over wide feature definitions 830 still covered by the passivation layer 890.

The polishing pressures used herein reduce or minimize damaging shear forces and frictional forces for substrates containing low k dielectric materials. Reduced or minimized forces can result in reduced or minimal deformations and defect formation of features from polishing. Further, the lower shear forces and frictional forces have been observed to reduce or minimize formation of topographical defects, such as erosion of dielectric materials and dishing of conductive materials as well as reducing delamination, during polishing. Contact between the substrate and a conductive polishing article also allows for electrical contact between the power source and the substrate by coupling the power source to the polishing article when contacting the substrate.

A removal rate of conductive material of up and about 15,000 Å/min can be achieved by the processes described herein. Higher removal rates are generally desirable, but due to the goal of maximizing process uniformity and other process variables (e.g., reaction kinetics at the anode and cathode) it is common for dissolution rates to be controlled between about 100 Å/min and about 15,000 Å/min, such as between about 2,000 Å/min and about 8,000 Å/min. In one embodiment of the invention where the copper material to be removed is less than 5,000 Å thick, the voltage (or current) may be applied to provide a removal rate between about 100 Å/min and about 5,000 Å/min. The substrate is typically exposed to the polishing composition and power application for a period of time sufficient to remove at least a portion or all of the desired material disposed thereon.

Referring to FIG. 8D, the process described herein may allow for the formation of a protrusion 900 in the conductive material 860 formed over the wide features. The protrusion 900 is formed from material that was unpolished or polished at a reduced removal rate due to the formation of a thicker or denser passivation layer or for longer durations than other portions of the conductive material 860. For example, the protrusion may be between about 5% an about 60% of the deposited conductive material thickness, such as between about 10% and about 40% of the deposited conductive material thickness. The processes described herein have been observed herein to produce a protrusion between about 20% and about 30% of the deposited material thickness. The desired level of protrusion of the deposited conductive material thickness may vary based on the processing factors, such as the respective removal rates of additional polishing steps and the duration of overpolishing, if any. In one example of a protrusion formation, a protrusion was formed by the process herein to have a protrusion height above the substrate surface between about 100 Å and about 1000 Å over a feature size greater than about 2 μm.

The amount or size of the protrusion 900 may be controlled by modifying or varying the removal rate profile of the first polishing process step. For example, by varying the chemistry of the polishing composition used in the process, the power application, such as power levels, the process parameters of a pulse modulation technique, or a combination thereof, may all be used to affect the size of the protrusion 900. With regard to the polishing compositions, the size of the protrusions may be controlled by the amount of corrosion inhibitor, chelating agents, the pH levels, or a combination thereof. The invention contemplates that the compositions described herein and the power applications described herein may be varied beyond the illustrative examples detailed herein to achieve the formation of a protrusion herein and/or the relative removal rates over wide and narrow feature definitions.

For example, increase amounts of corrosion inhibitor were observed to increase the amount protrusion over wide features as compared to reduced amounts of corrosion inhibitors. In one comparison example under identical polishing conditions for a polishing layer of about 11,500 Å thick with a step height of about 6,000 Å, a polishing process with a composition of 0.3 wt. % benzotriazole (BTA) as a corrosion inhibitor exhibited a protrusion height of about 4,200 Å, about a 36.5% protrusion of the deposited conductive material, and a polishing process with a composition of 0.2 wt. % BTA as a corrosion inhibitor exhibited a protrusion height of about 800 Å, about a 7% protrusion of the deposited conductive material. In another comparison example, under identical polishing conditions but different from the first comparison example, a polishing process with a composition of 0.3 wt. % BTA as a corrosion inhibitor exhibited a protrusion of about 2,500 Å, about a 22% protrusion of the deposited conductive material, and a polishing process with a composition of 0.2 wt. % BTA as a corrosion inhibitor exhibited a protrusion of about 0 Å, or no observable protrusion.

The pH of the composition has also been observed to affect the amount of protrusion. Compositions having less acidic pH levels, i.e., more basic pH levels, composition were observed to have greater protrusion height over composition with more acidic pH levels. For example, protrusions were observed to be formed at pH levels of greater than 4, for example between about 5 and about 6.5. In a comparison example under identical polishing conditions, a polishing process with a pH of 6 exhibited a protrusion height of about 3,000 Å, about a 26% protrusion of the deposited conductive material, a polishing process with a pH of about 5 exhibited a protrusion height of about 200 Å, about a 1.7% protrusion of the deposited conductive material, and a polishing process with a pH of about 4 exhibited a protrusion height of about 0 Å, or no observable protrusion height. Further, a balance of pH and corrosion inhibitor concentration may be used to provide for a selective amount of protrusion. For example a more basic pH level at a lower corrosion inhibitor concentration may produce the same amount of protrusion as a more acidic pH level with a greater corrosion inhibitor concentration.

Power application may also be adapted to control the amount of protrusion in the process. For example, with same or similar processing compositions, a power application with a greater amount of power application in the “on” portion of the pulse modulation technique exhibited greater protrusion height formation than a power application with a lesser amount of applied power in the “on” portion of the pulse modulation technique. Additionally, for protrusion removal in a second electrochemical mechanical processing step, a power application a power application with a lesser amount of power application in the “on” portion of the pulse modulation technique compared to the “off” portion exhibited planarization and protrusion removal.

Power applied during the process may be referenced as voltage, current, current density, wattage, or other suitable means for monitoring and controlling the anodic dissolution process. A greater amount of power application may be achieved, for example, by an increase in the power level, i.e., increase voltage, current, current density, or wattage, an increase in the duration of a power period or pulse, or a combination thereof. Power and pulse modulation techniques may be varied based on changes in the processing parameters, for example, different electrolyte composition, may have different conductivities, and may require different power levels and pulse modulations.

It is believed that when power is applied, the “on” position, the formation of the passivation layer may increase in thickness and/or density because of metal ions complexing with components of the passivation layer, and in the “off” position, the passivation layer is subject to more abrasion and removal, due to ion starvation in the electrolyte near the surface of the conductive material being removed. An increase in thickness or density of the passivation layer is believed to result in better chemical and/or electrical insulative properties as well as increased resistance to removal by abrasion.

Thus, an increase in the total power applied to the substrate, such as an increase in the duration or magnitude of the applied power has been observed to result in increased protrusion height. In one comparison example using a composition having 0.3 wt % BTA and a pH between about 5 and about 6.5 under similar processing conditions, a protrusion height of about 4,000 Å for a metal layer of about 11,500 Å or less, about a 35% protrusion of the deposited conductive material, was observed to be formed under an “on” only power application, while a pulse modulation technique of 5 seconds “on” and 5 seconds “off” has been observed to result in a protrusion height of less than 400 Å.

The two-step conductive material polishing process described herein allows for the second step to planarize the protrusion 900 with minimal or reduced topographical defects, including reduced or minimal dishing, minimal conductive material residue, increased substrate processing through put, reduced composition costs, especially on the second process step, with minimal or reduced overpolishing of the substrate surface as shown in FIGS. 8D-8F. The two-step conductive material processing process may result in a secondary protrusion 910 as shown in FIG. 8E or planarize the conductive material 860 with minimal or no protrusion formation. Alternatively, the bulk and residual material may be removed on one processing step with a protrusion as shown for example in FIG. 8E.

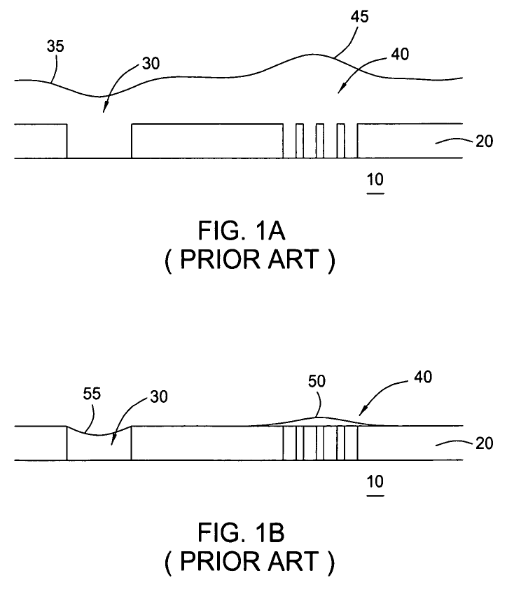

Residual material is removed with a second electrochemical mechanical polishing process. The second electrochemical mechanical polishing process provides a reduced removal rate compared to the first electrochemical mechanical polishing process step in order to prevent excess metal removal from forming topographical defects, such as concavities or depressions known as dishing D, as shown in FIG. 1A, and erosion E as shown in FIG. 1B as well as reducing delamination during polishing. Therefore, a majority of the conductive material 860 is removed at a faster rate during the first electrochemical mechanical polishing process than the remaining or residual conductive material 860 during the second electrochemical mechanical polishing process. The two-step electrochemical mechanical polishing process increases throughput of the total substrate processing while producing a smooth surface with little or no defects.

FIG. 8B illustrates the initiation of the second electrochemical mechanical polishing step after at least about 50% of the conductive material 860 was removed after the bulk removal of the first electrochemical mechanical polishing process, for example, about 90%. After the first electrochemical mechanical polishing process, conductive material 860 may still include the high overburden 870, peaks, and/or minimal overburden 880, valleys, but with a reduced proportional size. However, conductive material 860 may also be rather planar across the substrate surface (not pictured).

Referring to FIG. 8E, the residual conductive material may be polished by one or more additional polishing steps to provide a planarized substrate surface. The residual conductive material removal step may also provide for the formation of a protrusion 910 or planarize the substrate surface to the barrier layer completely. In one embodiment of the two-step conductive material polishing process further having a barrier polishing step, the second polishing step removes a portion of the protrusion, and the remainder of the protrusion is removed in the barrier polishing step as shown in FIGS. 8D-8F. The remaining protrusion of the conductive material can minimize or reduce dishing of the conductive material, such as copper, in the features during the CMP or Ecmp barrier polishing step.

Alternatively, the second polishing step may be used to remove the residual conductive material and all or a portion of the barrier layer material. In a further alternative polishing embodiment, the conductive material is removed by a first polishing step, the barrier is removed in a second polishing step, and any buffing or dielectric material, such as a polishing resistance capping layer, may be removed in a third polishing step by a chemical mechanical polishing process. Alternatively, the second conductive material, residual material step may be performed using a chemical mechanical polishing process.

The second conductive material polishing step may be performed by polishing the surface with a planarization efficiency, such as between about 10% and about 90%, such as between 20% and 80%, for example, between about 40% and about 60%. Such planarization efficiencies provide a second protrusion 910 between about 10% and about 90%, such as between 20% and 80%, for example, between about 40% and about 60%, of the protrusion 900 following the first polishing step. Planarization efficiency is defined as a reduction of the step height of deposited material, which in reference to FIG. 8D, comprises a reduction of the protrusion 900 as compared to any remaining residual material and/or the barrier layer.

The second electrochemical mechanical polishing step may be adapted to have material disposed on the substrate surface removed at higher removal rates over wide feature definitions as compared to the first polishing step or as compared to removal rates of material disposed over narrow feature definitions to provide for planarization of the conductive material. The relative removal rates of the second electrochemical mechanical polishing step may be adapted to be comparable to removal rate profiles observed in chemical mechanical polishing processes as described herein. If a third step is used to remove the barrier material layer, a third Ecmp process step may also be used as an alternative to a barrier CMP processing step.

An Ecmp removal rate profile of the second polishing process to polishing the substrate with protrusion removal and reduced or minimal dishing may be achieved by several approaches. In one example, a second Ecmp polishing step may be performed with a modified version of the first polishing composition under the same processing conditions. The modified composition for the second Ecmp processing step may include a lesser amount of corrosion inhibitor, a lesser abrasive concentration, or a more acidic pH level than the first Ecmp polishing step allowing for protrusion formation in the first polishing step and no protrusion development in the second polishing step.

Additionally, a separate polishing composition may be used in the second polishing process to achieve the desired polishing profile. The second Ecmp composition that have been observed to provide effective polishing results include minimal abrasive or abrasive free polishing compositions. The second polishing composition may also for a secondary passivation layer (not shown) as described above for the passivation layer 890. An example of the second polishing composition for the residual removal step includes between about 1 vol. % and about 10 vol. % of an acid based electrolyte, between about 0.1 wt % and about 6 wt % of a chelating agent, between about 0.01 wt. % and about 1 wt. % of a corrosion inhibitor, between about 0.001 vol. % and about 2 vol. % of a passivating polymeric material, between about 1 wt. % and about 20 wt. % of a pH adjusting agent, a solvent, and a pH between about 4 and less than about 7. The residual polishing composition has a conductivity of between about 20 and about 80 milliSiemens/centimeter (mS/cm), for example, between about 30 and about 60 milliSiemens/centimeter (mS/cm).

A further example of a polishing composition includes about 6 vol. % of 85% aqueous phosphoric acid (H₃PO₄) solution, about 2 wt. % of 98% ammonium citrate, about 0.3 wt. % of 99% benzotriazole, about 0.5 vol. % of L-2001 (L-2001 has about <1% heterocyclic polymer/amine polymer solution), about 0.025 vol. % of 750000 molecular weight 50% polyethylene imine (PEI) solution, deionized water, and potassium hydroxide (KOH) to provide a pH of about 5.75 (with sufficient amounts of 45% KOH solution) Further description of the example residual processing step composition and process step for using the composition are further described in U.S. patent application Ser. No. 11/123,274, filed on May 5, 2005, and in U.S. patent application Ser. No. 11/251,630, filed on Oct. 14, 2005, both of which are incorporated by reference herein to the extent not inconsistent with the description and claimed aspects herein.

The removal rate profile may be achieved by an electrical based process including a pulse modulation technique for the second polishing step may be used that increases removal rate over wide features as compared to a pulse modulation technique in the first polishing step to control protrusion formation and relative removal rates. A combination of corrosion inhibitor concentrations, pH levels, and pulse modulation techniques may be used for both the first and second polishing steps to provide the desired removal rate profiles to produce or remove protrusions as desired.

An example of the residual polishing step is provided as follows. Except otherwise noted, the processing parameters are the same ranges as provided for the bulk polishing step described herein.

The polishing composition may be provided at a flow rate between about 50 and about 800 milliliters per minute, such as about 300 milliliters per minute, to the substrate surface. The mechanical abrasion in the above residual processing step is performed at a contact pressure between about 0.1 (0.7 kPa) psi and about 0.8 psi (5.5 kPa), such as at a pressure of about 0.3 psi (2.1 kPa). Alternatively, the pressure of the second electrochemical mechanical polishing step may be reduced compared to the bulk polishing step to further reduce the removal rate of the copper material. The conductive polishing article assembly disposed on the platen is rotated at a rotational rate of between about 7 rpm and about 80 rpm, such as between about 7 rpm and about 50 rpm, for example, about 20 rpm, and the substrate disposed in a carrier head is rotated at a rotational rate between about 7 rpm and about 80 rpm, such as between about 7 rpm and about 70 rpm, for example, about 21 rpm. A voltage of between about 1.5 volts and about 3 volts, such as 2 volts, may be used as the applied bias in the second electrochemical processing step. The substrate is typically exposed to the polishing composition and power application for a period of time sufficient to remove at least a portion or all of the desired material disposed thereon. The process may also be performed at a temperature between about 20° C. and about 60° C.

The two step process described above was observed to have a very high planarization efficiency, greater than 90% and in some processes, up to 100% efficiency. Planarization efficiency is the percentage reduction of the difference in height between the high overburden 870 and the minimal overburden 880, or alternatively between the height of the protrusion 900 and the remaining conductive material, with 100% efficiency being understood and the complete removal of the difference in height between the two points.

Referring to FIGS. 8E and 8F, the barrier layer and any protrusion of the conductive material may be removed by a by CMP or Ecmp processes. The barrier layer may be selectively or non-selectively removed compared to the conductive material. The composition for barrier layer removal may provide a barrier material selectivity at a removal rate ratio of barrier material to conductive material between greater than about 1:1 to about 5:1, which may vary on protrusion height. Alternatively, the compositions may have removal rate ratios of conductive material to barrier material to dielectric material of about 1:1:1.

The barrier layer may be removed by CMP or Ecmp processes, for example, as described in U.S. patent application Ser. No. 11/130,032, dated May 16, 2005, which is incorporated by reference herein to the extent not inconsistent with the claimed aspects and disclosure herein. Alternatively, the barrier material may be removed with a CMP process having a commercial composition, such as the 6605 and 6618 compositions from Cabot Corp. of Aurora, Ill. The barrier removal process may comprise a chemical mechanical polishing process with a hard article or soft article conventional CMP polishing article as described herein with an abrasive or abrasive free polishing composition.

After conductive material and barrier material removal processing steps, the substrate may then be buffed to minimize surface defects. Buffing may be performed with a soft polishing article, i.e., a hardness of about 40 or less on the Shore D hardness scale as described and measured by the American Society for Testing and Materials (ASTM), headquartered in Philadelphia, Pa., at reduced polishing pressures, such as about 2 psi or less.

Optionally, a cleaning solution may be applied to the substrate after each of the polishing processes to remove particulate matter and spent reagents from the polishing process as well as help minimize metal residue deposition on the polishing articles and defects formed on a substrate surface. An example of a suitable cleaning solution is Electra Clean™, commercially available from Applied Materials, Inc., of Santa Clara, Calif.

Finally, the substrate may be exposed to a post polishing cleaning process to reduce defects formed during polishing or substrate handling. Such processes can minimize undesired oxidation or other defects in copper features formed on a substrate surface. An example of such a post polishing cleaning is the application of Electra Clean™, commercially available from Applied Materials, Inc., of Santa Clara, Calif.

It has been observed that substrate planarized by the processes described herein have exhibited reduced topographical defects, such as dishing and erosion, reduced residues, improved planarity, and improved substrate finish.

Polishing Composition

In one aspect, polishing compositions that can planarize metals, such as copper, for the bulk polishing step described above with regard to protrusion formation are provided as follows. Generally, the polishing composition comprises an acid based electrolyte system, a corrosion inhibitor, an organic acid salt, a pH adjusting agent to provide a pH between about 2 and about 10, and a solvent. The polishing composition may alternatively include a polymeric passivation material, a chelating agent having an amine or amide functional group, a surfactant, abrasive particles, an oxidizer, and combinations thereof, and a solvent.

The invention contemplates that the solution described herein may be further diluted in preparation for application to the substrate surface, such as an abrasive slurry may be mixed with composition, and the slurry may comprise up to 70% solvent. It is believed that the polishing compositions described herein improve the effective removal rate of materials from the substrate surface, such as copper, during ECMP, with a reduction in planarization type defects and yielding a smoother substrate surface.

Although the polishing compositions are particularly useful for removing copper, it is believed that the polishing compositions also may be used for the removal of other conductive materials, such as aluminum, platinum, tungsten, cobalt, gold, silver, ruthenium and combinations thereof. Mechanical abrasion, such as from contact with the conductive article 203 and/or abrasives, may be used to improve planarity and improve removal rate of these conductive materials.

The polishing composition includes an acid based electrolyte system for providing electrical conductivity. Suitable acid based electrolyte systems include an acid electrolyte, such as phosphoric acid and/or sulfuric acid, an acid electrolyte derivative, including ammonium and potassium salts thereof, and combinations thereof. Suitable acid based electrolyte systems include, for example, sulfuric acid based electrolytes, phosphoric acid based electrolytes, perchloric acid based electrolytes, nitric acid based electrolytes, and combinations thereof. The acid based electrolyte system may also buffer the composition to maintain a desired pH level for processing a substrate.

Examples of suitable acid based electrolytes include compounds having a phosphate group (PO₄³⁻), such as, phosphoric acid, compounds having a nitrite group (NO₃¹⁻), such as, nitric acid, compounds having a boric group (BO₃³⁻), such as, orthoboric acid (H₃BO₃) and compounds having a sulfate group (SO₄²⁻), such as sulfuric acid (H₂SO₄). More than one acid base electrolyte may be used in the composition, for example, an electrolyte system of phosphoric acid and nitric acid may be used in one embodiment of the composition described herein. Suitable acid based electrolytes having an acid salt include copper phosphate, potassium phosphates (KₓH₍₃₋ₓ₎PO₄) (x=1, 2 or 3), such as potassium dihydrogen phosphate or potassium phosphate monobasic (KH₂PO₄), dipotassium hydrogen phosphate or potassium phosphate dibasic (K₂HPO₄), potassium phosphate tribasic (K₃PO₄), ammonium phosphates ((NH₄)ₓH₍₃₋ₓ₎PO₄) (x=1, 2 or 3), such as ammonium phosphate monobasic (ammonium dihydrogen phosphate) ((NH₄)H₂PO₄), ammonium phosphate dibasic (diammonium hydrogen phosphate) ((NH₄)₂HPO₄), and combinations thereof. Other suitable acid based electrolytes having an acid salt include copper nitrate, ammonium hydrogen sulfate ((NH₄)HSO₄), ammonium sulfate, potassium sulfate, copper sulfate, derivatives thereof and combinations thereof. The invention also contemplates that conventional electrolytes known and unknown may also be used in forming the composition described herein using the processes described herein.

The acid based electrolyte system may contains an acidic component that can take up about 1 to about 30 percent by weight (wt. %) of the total composition of solution to provide suitable conductivity for practicing the processes described herein. One example of an electrolyte system includes between about between about 1 wt. % and about 20 wt. % of an electrolyte, for example, potassium phosphate monobasic (KH₂PO₄), phosphoric acid, or 85% phosphoric acid solution, such as between about 4 wt. % and about 15 wt. %, for example, between about 8 wt. % and about 12 wt. % of the electrolyte in the composition. Another example of an electrolyte system includes between about between about 1 wt. % and about 25 wt. % potassium phosphate dibasic (K₂HPO₄), such as between about 5 wt. % and about 18 wt. % potassium phosphate dibasic, for example, about 15 wt. % potassium phosphate monobasic in the composition. Another example of an electrolyte system includes between about between about 1 wt. % and about 25 wt. % potassium phosphate dibasic (K₂HPO₄), such as between about 6 wt. % and about 20 wt. % potassium phosphate dibasic, for example, about 15 wt. % potassium phosphate monobasic in the composition. The acid based electrolyte system may also be added in solution, for example, phosphoric acid may be from 85% aqueous phosphoric acid solution. Where possible solutions of composition constituents have been included in the examples.

Generally, Ecmp compositions are much more conductive than traditional CMP solutions. Ecmp solutions using an electrolyte system have a conductivity of about 10 milliSiemens (mS) or higher, while traditional CMP solutions have a conductivity from about 3 mS to about 5 mS. The conductivity of the Ecmp solutions greatly influences the rate at which the Ecmp process advances, i.e., more conductive solutions have a faster material removal rate. For removing bulk material, the Ecmp solution has a conductivity of about 10 mS or higher, preferably in a range between about 40 mS and about 80 mS, for example, between about 50 mS and about 70 mS.

The bulk polishing composition also includes salts of a compound including a carboxylate functional group, an organic acid salt. Carboxylate functional groups include dicarboxylate groups, tricarboxylate groups, and combinations thereof. While the salts of a compound including a carboxylate functional group may be free of hydroxyl group or an amine group, the invention contemplates the salts of a compound including a carboxylate functional group may further include a hydroxyl group, an amine group, or combinations thereof. The organic acid salts may also function as chelating agents in the composition and processes described herein.

The salts may include chelating agents may include ammonium oxalate, ammonium citrate compounds including ammonium citrate monobasic ammonium citrate dibasic, and ammonium citrate tribasic, ammonium succinate, monobasic potassium citrate, dibasic potassium citrate, tribasic potassium citrate, potassium tartarate, ammonium tartarate, potassium succinate, potassium oxalate, and combinations thereof. The salts may have multi-basic states, for example, citrates have mono-, di- and tri-basic states. Other suitable acids having a carboxylate groups include citric acid, tartaric acid, succinic acid, oxalic acid, acetic acid, adipic acid, butyric acid, capric acid, caproic acid, caprylic acid, glutaric acid, glycolic acid, formaic acid, fumaric acid, lactic acid, lauric acid, malic acid, maleic acid, malonic acid, myristic acid, plamitic acid, phthalic acid, propionic acid, pyruvic acid, stearic acid, valeric acid, derivatives thereof, salts thereof and combinations thereof.

Suitable organic acid salts are preferably free of a hydroxyl functional group or an amine group, however, the organic acid salt may include such functional groups. Examples of salts of a compound including a carboxylate functional group that may further include a hydroxyl group, an amine group, or combinations thereof, include salts of glycolic acid, amino acids, such as glycine, imidoacetic acid, and ethylenediaminetetraacetic acid (EDTA) salts, such as sodium, potassium and calcium (e.g., Na₂EDTA, Na₄EDTA, K₄EDTA or Ca₂EDTA).

The organic acid salts may be present at a concentration between about 0.1 wt. % and about 15% wt. % of the composition. In one embodiment of the composition the organic acid concentration includes between about 0.2 wt. % and about 6 wt. % by volume or weight, such as between about 0.4 wt. % and about 3 wt. %, for example, between about 1 wt. % and about 3 wt. %. The organic acid salts may also be added in solution or in a substantially pure form, for example, ammonium citrate may be added in a 98% pure form.

In an alternative embodiment, an organic acid, such as those described above for the organic acid salt may be used in addition to or as a substitute of the organic acid salt. The organic acid may be present at a concentration between about 0.1 wt. % and about 15% wt. % of the composition, for example, between about 0.2 wt. % and about 6 wt. % by volume or weight.

In any of the embodiments described herein, corrosion inhibitors can be added to reduce the oxidation or corrosion of metal surfaces by enhancing the formation of the passivation layer that minimizes the chemical interaction between the substrate surface and the surrounding electrolyte. The layer of material formed by the corrosion inhibitors thus tends to suppress or minimize the electrochemical current from the substrate surface to limit electrochemical deposition and/or dissolution.

Suitable corrosion inhibitors include compounds having a nitrogen atom (N), such as organic compounds having an azole group. Examples of suitable compounds include benzotriazole (BTA), mercaptobenzotriazole, 5-methyl-1-benzotriazole (TTA), and combinations thereof. Other suitable corrosion inhibitors include film forming agents that are cyclic compounds, for example, imidazole, benzimidazole, triazole, and combinations thereof. Derivatives of benzotriazole, imidazole, benzimidazole, triazole, with hydroxy, amino, imino, carboxy, mercapto, nitro and alkyl substituted groups may also be used as corrosion inhibitors. Other corrosion inhibitor includes urea and thiourea among others.

The polishing composition may include between about 0.001 wt. % and about 5.0 wt. % of corrosion inhibitors having an azole group, such as between about 0.05 wt. % and about 0.6 wt. %, including between about 0.1 wt. % and about 0.4 wt. %, for example, between about 0.2 wt. % and about 0.3 wt. % of the corrosion inhibitors. The corrosion inhibitor may also be added in solution or in a substantially pure form, for example, benzotriazole may be added in a 99% pure form.

Additionally, a polymeric passivating agent may be used in the compositions described herein. Suitable polymeric passivating agents are polymeric inhibitors of compounds having a nitrogen atom (N), an oxygen atom (O), or a combination of the two. Polymeric inhibitors include ethylene imine (C₂H₅N) based polymeric materials, such as polyethylene imine (PEI) having a molecular weight between about 400 and about 1000000 comprising (—CH₂—CH₂—NH—) monomer units, ethylene glycol (C₂H₆O₂) based polymeric materials, such as polyethylene glycol (PEG) having a molecular weight between about 200 and about 100000 comprising (OCH₂CH₂)_{N} monomer units, or combinations thereof. Polycarboxylic acids, polyamines and polyimides may also be used as polymeric inhibitors in the composition. Other suitable polymeric inhibitors include oxide polymers, such as, polypropylene oxide and ethylene oxide/propylene oxide co-polymer (EOPO), with a Molecular Weight range between about 200 and about 100000.

Additionally, the polymeric inhibitors may comprise polymers of heterocyclic compounds containing nitrogen and/or oxygen atoms, such as polymeric materials derived from monomers of pyridine, pyrole, furan, purine, or combinations thereof. The polymeric inhibitors may also include polymers with both linear and heterocyclic structural units containing nitrogen and/or oxygen atoms, such as a heterocyclic structural units and amine or ethylene imine structural units. The polymeric inhibitors may also include carbon containing functional groups or structural units, such as homocyclic compounds, such as benzyl or phenyl functional groups, and linear hydrocarbons suitable as structural units or as functional groups to the polymeric backbone. A mixture of the polymeric inhibitors described herein is also contemplated, such as a polymeric mixture of a heterocyclic polymer material and an amine or ethylene imine polymeric material (polyethylene imine). An example of a suitable polymeric inhibitor includes XP-1296 (also known as L-2001), containing a heterocyclic polymer/polyamine polymer, commercially available from Rohm and Hass Electronic Materials of Marlborough, Mass., and Compound S-900, commercially available from Enthone-OMI Inc. of New Haven, Conn.

The polymeric inhibitor may be present in the composition of this invention in amounts ranging between about 0.001 wt. % and about 2 wt. %, such as between about 0.005 wt. % and about 1 wt. %, for example, between about 0.01 wt. % and about 0.5 vol. %. A polymeric inhibitor of 2000 or 750000 molecular weight polyethylene imine in a concentration of about 0.025 wt. % may be used in the composition. More than one polymeric inhibitor may be included in the polishing composition. Some polymeric inhibitor may be added the composition in a solution, for example, the polishing composition may include 0.5 wt. % PEI with a 2000 molecular weight of a 5% aqueous PEI solution and/or 0.5 wt. % XP-1296 (or XP tradename family of compounds from Rohm and Haas) with a 2000 molecular weight of a 10% aqueous XP-1296 solution. Alternatively, the polymeric inhibitors described herein may be added in limited amounts, such as between about 5 parts per million (ppm, 0.0001 % by weight or volume) and about 100 ppm.

Polymeric inhibitors may be in a dilute form from manufacturing, for example, polyethylene imine may be added to a composition from a 50% polyethylene imine solution, so the concentration of the solution may be 0.025 wt. % and the actual polyethylene imine concentration would be about 0.0125 wt. %. Thus, the invention contemplates that the percentages of all of the components, including the polymeric inhibitors, reflect both dilute compounds provided from their manufacturing source as well as the actual present amount of the component.

Alternatively, polymeric inhibitors, for non-limiting examples, polyalkylaryl ether phosphate or ammonium nonylphenol ethoxylate sulfate, may be used in replacement or conjunction with azole containing corrosion inhibitors in an amount between about 0.002% and about 1.0% by volume or weight of the composition.

A pH adjusting agent is preferably added to the polishing composition to achieve a pH between about 2 and about 10, and preferably an acidic pH between about 4 and less than about 7, for example, a pH between about 4.5 and about 6.5. The amount of pH adjusting agent can vary as the concentration of the other components is varied in different formulations, but in general the total solution may include up and about 70 vol. % of The pH adjusting agent, but preferably between about 0.2% and about 25% by volume (vol. %). The pH adjusting agent can also be a base, or basic, pH adjusting agent, for example, selected from a group of potassium hydroxide, ammonium hydroxide, sodium hydroxide or combinations thereof, among others.

Different compounds may provide different pH levels for a given concentration, for example, the composition may include between about 0.1% and about 10% by volume, such as between about 0.5% and about 6% by volume of a base, such as potassium hydroxide, ammonium hydroxide, sodium hydroxide or combinations thereof, providing the desired pH level. The pH adjusting agent may be referred to as in a pure state or added the composition in a solution, for example, the residual polishing composition may include potassium hydroxide (KOH) or potassium hydroxide in a 40% or 45% potassium hydroxide solution. For example, the composition may include between about 0.5% and about 3% by volume of 45% potassium hydroxide. Where possible, the reference to the 45% potassium hydroxide solution has been made in the description herein.

The pH adjusting agent can also be an acid, or acidic, pH adjusting agent, for example, selected from a class of inorganic acids including phosphoric acid, sulfuric acid, hydrochloric, nitric acid, derivatives thereof and combinations thereof. The acid pH adjusting agent may also be added in solution, for example, phosphoric acid may be from 85% aqueous phosphoric acid solution. The pH adjusting agent may have electrolytic properties and may be added in combination with the electrolyte.

The balance or remainder of the polishing compositions described herein is a solvent, such as a polar solvent, including water, preferably deionized water. Other solvent may be used solely or in combination with water, such as organic solvents. Organic solvents include alcohols, such as isopropyl alcohol or glycols, ethers, such as diethyl ether, furans, such as tetrahydrofuran, hydrocarbons, such as pentane or heptane, aromatic hydrocarbons, such as benzene or toluene, halogenated solvents, such as methylene chloride or carbon tetrachloride, derivatives, thereof and combinations thereof.

In another alternative embodiment of the composition, the composition may further include a chelating agent comprises a molecule having a nitrogen containing functional group in addition to the organic acid salt. Nitrogen containing function groups include amine functional groups, amide functional groups, pyridyl functional groups, and combinations thereof. Suitable chelating agents comprising a molecule having a nitrogen containing functional group may be free of a carboxylate functional group.

Examples of suitable chelating agents having an amine or amide functional group can include compounds such as ethylenediamine (EDA), diethylenetriamine, diethylenetriamine derivatives, hexadiamine, amino acids, glycine, methylformamide, derivatives thereof, salts thereof or combinations thereof. Examples of suitable chelating agents having a pyridyl group includes for example, 2,2′-dipyridyl, among others.

The chelating agent having nitrogen containing functional group may be in the composition at a concentration between about 0.1 wt. % and 15 wt. %, such as between about 0.2 wt. % and about 4 wt. % of the composition. For example, between about 0.5 wt. % and about 2 wt. % of ethylenediamine may be used as a chelating agent an amine or amide functional group.

One aspect or component of the present invention is the use of a chelating agent to complex with the surface of the substrate to enhance the electrochemical dissolution process. In any of the embodiments described herein, the chelating agents can bind to a conductive material, such as copper ions, increase the removal rate of metal materials and/or improve dissolution uniformity across the substrate surface. The metal materials for removal, such as copper, may be in any oxidation state, such as 0, 1, or 2, before, during or after ligating with a functional group. The functional groups can bind the metal materials created on the substrate surface during processing and remove the metal materials from the substrate surface. The chelating agents may also be used to buffer the bulk polishing composition to maintain a desired pH level for processing a substrate. The chelating agents may also form or enhance the formation of the second passivation layer on the substrate surface.

While the bulk polishing composition may be described as oxidizer free and/or abrasive free polishing compositions, an alterative embodiment of the composition may include abrasive particles, an oxidizer, or combinations thereof.

Abrasive particles, referred to as abrasives, may comprise up and about 30 wt. % of the residual polishing composition during processing, such as a concentration between about 0.001 wt. % and about 5 wt. %, for example, between about 0.05 wt. % and about 2 wt. %, of abrasive particles in the bulk polishing composition. The abrasive particles may be added from a colloidal suspension, such as 30 wt % abrasive (e.g., silica) suspension in a solvent. For example, the 2 wt. % of abrasive particles may be 2 wt. % of silica suspension providing a 0.6 wt. % of abrasive particles to the composition.

Suitable abrasives particles include inorganic abrasives, polymeric abrasives, and combinations thereof. Inorganic abrasive particles that may be used in the electrolyte include, but are not limited to, silica, alumina, zirconium oxide, titanium oxide, cerium oxide, germania, or any other abrasives of metal oxides, known or unknown. For example, colloidal silica may be positively activated, such as with an alumina modification or a silica/alumina composite. The typical abrasive particle size used in one embodiment of the current invention is generally between about 1 nm and about 1,000 nm, preferably between about 10 nm and about 100 nm. Generally, suitable inorganic abrasives have a Mohs hardness of greater than 6, although the invention contemplates the use of abrasives having a lower Mohs hardness value.

The polymer abrasives described herein may also be referred to as “organic polymer particle abrasives”, “organic abrasives” or “organic particles.” The polymeric abrasives may comprise abrasive polymeric materials. Examples of polymeric abrasives materials include polymethylmethacrylate, polymethyl acrylate, polystyrene, polymethacrylonitrile, and combinations thereof.

The polymeric abrasives may have a Hardness Shore D of between about 60 and about 80, but can be modified to have greater or lesser hardness value. The softer polymeric abrasive particles can help reduce friction between a polishing article and substrate and may result in a reduction in the number and the severity of scratches and other surface defects as compared to inorganic particles. A harder polymeric abrasive particle may provide improved polishing performance, removal rate and surface finish as compared to softer materials. The hardness of the polymer abrasives can be varied by controlling the extent of polymeric cross-linking in the abrasives, for example, a higher degree of cross-linking produces a greater hardness of polymer and, thus, abrasive. The polymeric abrasives are typically formed as spherical shaped beads having an average diameter between about 0.1 micron and about 20 microns or less.

The polymeric abrasives may be modified to have functional groups, e.g., a functional groups, that have an affinity for, i.e., can bind to, the conductive material or conductive material ions at the surface of the substrate, thereby facilitating the electrochemical mechanical polishing removal of material from the surface of a substrate. For example, if copper is to be removed in the polishing process, the organic polymer particles can be modified to have an amine group, a carboxylate group, a pyridine group, a hydroxide group, ligands with a high affinity for copper, or combinations thereof, to bind the removed copper as substitutes for or in addition to the chemically active agents in the bulk polishing composition, such as the chelating agents or corrosion inhibitors. The substrate surface material, such as copper, may be in any oxidation state, such as 0, 1+, or 2+, before, during or after ligating with a functional group. The functional groups can bind to the metal material(s) on the substrate surface to help improve the uniformity and surface finish of the substrate surface.

Additionally, the polymeric abrasives have desirable chemical properties, for example, the polymer abrasives are stable over a broad pH range and are not prone to aggregating to each other, which allow the polymeric abrasives to be used with reduced or no surfactant or no dispersing agent in the composition.

Alternatively, inorganic particles coated with the polymeric materials described herein may also be used with the bulk polishing composition. It is within the scope of the current invention for the bulk polishing composition to contain polymeric abrasives, inorganic abrasives, the polymeric coated inorganic abrasives, and any combination thereof depending on the desired polishing performance and results.

Alternatively, one or more surfactants may be used in the polishing composition. Surfactants may be used to increase the dissolution or solubility of materials, such as metals and metal ions or by-products produced during processing, reduce any potential agglomeration of abrasive particles in the polishing composition, and improve chemical stability and reduce decomposition of components of the polishing composition. The one or more surfactants can comprise a concentration between about 0.001% and about 10% by volume or weight of the polishing composition. A concentration between about 0.05% and about 2% by volume or weight, may be used in one embodiment of the polishing composition.

The one or more surfactants may include non-ionic surfactants as well as ionic surfactants including anionic surfactants, cationic surfactants, amphoteric surfactants, and ionic surfactants having more than one ionic functional group, such as Zweitter-ionic surfactants. Dispersers or dispersing agents are considered to be surfactants as surfactants are used herein. Compositions containing the polymeric abrasives are stable over a broad pH range and are not prone to aggregating to each other, which allow the abrasives to be used with reduced or no surfactant or no dispersing agent in the composition.

Optionally, the bulk polishing composition may include an oxidizers. The oxidizer can be present in the polishing composition in an amount ranging between about 0.01% and about 100% by volume or weight, for example, between about 0.1% and about 20% by volume or weight. In an embodiment of the polishing composition, between about 0.1% and about 15% by volume or weight of hydrogen peroxide is present in the polishing composition. The oxidizer may be added to the composition in a solution, such as a 30% aqueous hydrogen peroxide solution or a 40% aqueous hydrogen peroxide solution.

In one embodiment, the oxidizer is added to the rest of the polishing composition just prior to beginning the electrochemical mechanical polishing process. Examples of suitable oxidizers include peroxy compounds, e.g., compounds that may disassociate through hydroxy radicals, such as hydrogen peroxide and its adducts including urea hydrogen peroxide, percarbonates, and organic peroxides including, for example, alkyl peroxides, cyclical or aryl peroxides, benzoyl peroxide, peracetic acid, and ditertbutyl peroxide. Sulfates and sulfate derivatives, such as monopersulfates and dipersulfates may also be used including for example, ammonium peroxydisulfate, potassium peroxydisulfate, ammonium persulfate, and potassium persulfate. Salts of peroxy compounds, such as sodium percarbonate and sodium peroxide may also be used.

The oxidizer can also be an inorganic compound or a compound containing an element in its highest oxidation state. Examples of inorganic compounds and compounds containing an element in its highest oxidation state include but are not limited to periodic acid, periodate salts, perbromic acid, perbromate salts, perchloric acid, perchloric salts, perbonic acid, nitrate salts (such as cerium nitrate, iron nitrate, ammonium nitrate), ferrates, perborate salts and permanganates. Other oxidizers include bromates, chlorates, chromates, iodates, iodic acid, and cerium (IV) compounds such as ammonium cerium nitrate.

The polishing composition may include an additive compounds. Additive compounds include electrolyte additives including, but not limited to, suppressors, enhancers, levelers, brighteners, stabilizers, and stripping agents to improve the effectiveness of the residual polishing composition in polishing of the substrate surface. For example, certain additives may decrease the ionization rate of the metal atoms, thereby inhibiting the dissolution process, whereas other additives may provide a finished, shiny substrate surface. The additives may be present in the residual polishing composition in concentrations up and about 15% by weight or volume, and may vary based upon the desired result after polishing. Further examples of additives to the polishing composition are more fully described in U.S. patent application Ser. No. 10/456,220, filed on Jun. 6, 2003, which is incorporated by reference herein to the extent not inconsistent with the claimed aspects and disclosure herein.

The following non-limiting examples are provided to further illustrate embodiments of the invention. However, the examples are not intended to be all inclusive and are not intended to limit the scope of the invention described herein.

### EXAMPLE 1

A copper plated substrate was polished and planarized using the following polishing composition within a modified cell on a Reflection® system, available from Applied Materials, Inc. of Santa Clara, Calif.
about 12 wt. % potassium phosphate monobasic;
about 1% by volume ethylenediamine;
about 2% by weight ammonium citrate tribasic;
about 0.3% by weight benzotriazole;
between about 0.5% and about 3% by volume of 85% phosphoric acid solution to provide a pH between about 4.5 and about 6; and
deionized water.

### EXAMPLE 2

A copper plated substrate was polished and planarized using the following polishing composition within a modified cell on a Reflection® system, available from Applied Materials, Inc. of Santa Clara, Calif.
about 12 wt. % potassium phosphate monobasic;
about 1% by volume ethylenediamine;
about 2% by weight ammonium citrate tribasic;
about 0.3% by weight benzotriazole;
between about 0.5% and about 6% by volume of 45% potassium hydroxide to provide a pH of about 5; and
deionized water.

### EXAMPLE 3

A copper plated substrate was polished and planarized using the following polishing composition within a modified cell on a Reflection® system, available from Applied Materials, Inc. of Santa Clara, Calif.
about 12 wt. % potassium phosphate monobasic;
about 1% by volume ethylenediamine;
about 2% by weight imidoacetic acid;
about 0.3% by weight benzotriazole;
between about 0.5% and about 3% by volume of 85% phosphoric acid solution to provide a pH between about 4.5 and about 6; and
deionized water.

### EXAMPLE 4

A copper plated substrate was polished and planarized using the following polishing composition within a modified cell on a Reflection® system, available from Applied Materials, Inc. of Santa Clara, Calif.
about 4 wt. % potassium phosphate monobasic;
about 1.7% by volume ethylenediamine;
about 2% by weight ammonium citrate tribasic;
about 0.3% by weight benzotriazole;
between about 2% and about 4% by volume of nitric acid to provide a pH between about 4 and about 6; and
deionized water.

### EXAMPLE 5

A copper plated substrate was polished and planarized using the following polishing composition within a modified cell on a Reflection® system, available from Applied Materials, Inc. of Santa Clara, Calif.
about 4 wt. % potassium phosphate monobasic;
about 1.7% by volume ethylenediamine;
about 2% by weight ammonium citrate tribasic;
about 0.3% by weight benzotriazole;
between about 2% and about 5% by volume of 85% phosphoric acid solution to provide a pH between about 5 and about 6; and
deionized water.

### EXAMPLE 6

A copper plated substrate was polished and planarized using the following polishing composition within a modified cell on a Reflection® system, available from Applied Materials, Inc. of Santa Clara, Calif.
about 10 wt. % of 85% phosphoric acid solution;
about 2% by weight ammonium citrate tribasic;
about 0.3% by weight benzotriazole;
about 0.5 vol % of L-2001
about 0.015 vol % polyethylene imine with a molecular weight of 750000
between about 0.5% and about 5% by volume of ammonium hydroxide to provide a pH between about 5.5 and about 6.5; and
deionized water.

### EXAMPLE 7

A copper plated substrate was polished and planarized using the following polishing composition within a modified cell on a Reflection® system, available from Applied Materials, Inc. of Santa Clara, Calif.
about 7 wt. % of 85% phosphoric acid solution;
about 1 wt. % nitric acid;
about 2% by weight ammonium citrate tribasic;
about 0.3% by weight benzotriazole;
about 0.5 vol % of L-2001
about 0.015 vol % polyethylene imine with a molecular weight of 750000
between about 0.5% and about 5% by volume of 45% potassium hydroxide to provide a pH between about 5.5 and about 6.5; and
deionized water.

### EXAMPLE 8

A copper plated substrate was polished and planarized using the following polishing composition within a modified cell on a Reflection® system, available from Applied Materials, Inc. of Santa Clara, Calif.
about 12 wt. % potassium phosphate monobasic;
about 2% by weight ammonium citrate tribasic;
about 0.3% by weight benzotriazole;
between about 0.5% and about 6% by volume of 45% potassium hydroxide to provide a pH of about 6; and
deionized water.

### EXAMPLE 9

A copper plated substrate was polished and planarized using the following polishing composition within a modified cell on a Reflection® system, available from Applied Materials, Inc. of Santa Clara, Calif.
about 12 wt. % potassium phosphate monobasic;
about 2% by weight ammonium citrate tribasic;
about 0.3% by weight benzotriazole;
between about 0.5% and about 6% by volume of 45% potassium hydroxide to provide a pH between about 5 and about 6.5; and
deionized water.

### EXAMPLE 10

A copper plated substrate was polished and planarized using the following polishing composition within a modified cell on a Reflection® system, available from Applied Materials, Inc. of Santa Clara, Calif.
about 6 wt. % potassium phosphate monobasic;
about 2 wt. % nitric acid;
about 2% by weight ammonium citrate tribasic;
about 0.3% by weight benzotriazole;
between about 0.5% and about 5% by volume of ammonium hydroxide to provide a pH between about 5 and about 6.5; and
deionized water.

### EXAMPLE 11

A copper plated substrate was polished and planarized using the following polishing composition within a modified cell on a Reflection® system, available from Applied Materials, Inc. of Santa Clara, Calif.
about 11 wt. % potassium phosphate monobasic;
about 2% by weight ammonium citrate tribasic;
about 0.3% by weight benzotriazole;
about 0.2 wt. % of colloidal silica (30% silica colloidal suspension)
between about 0.5% and about 3% by volume of 45% potassium hydroxide to provide a pH between about 5 and about 6.5; and
deionized water.

### EXAMPLE 12

A copper plated substrate was polished and planarized using the following polishing composition within a modified cell on a Reflection® system, available from Applied Materials, Inc. of Santa Clara, Calif.
about 11 wt. % potassium phosphate monobasic;
about 2% by weight ammonium citrate tribasic;
about 0.3% by weight benzotriazole;
about 0.2 wt. % of colloidal silica (30% silica colloidal suspension)
between about 0.5% and about 3% by volume of ammonium hydroxide to provide a pH between about 5 and about 6.5; and
deionized water.

### EXAMPLE 13

A copper plated substrate was polished and planarized using the following polishing composition within a modified cell on a Reflection® system, available from Applied Materials, Inc. of Santa Clara, Calif.
about 15 wt. % potassium phosphate dibasic;
about 1% by volume ethylenediamine;
about 2% by weight ammonium citrate tribasic;
about 0.3% by weight benzotriazole;
between about 0.5% and about 6% by volume of 85% phosphoric acid solution to provide a pH between about 5 and about 6; and
deionized water.

### EXAMPLE 14

A copper plated substrate was polished and planarized using the following polishing composition within a modified cell on a Reflection® system, available from Applied Materials, Inc. of Santa Clara, Calif.
about 15 wt. % potassium phosphate dibasic;
about 1% by volume ethylenediamine;
about 2% by weight ammonium citrate tribasic;
about 0.3% by weight benzotriazole;
between about 0.5% and about 6% by volume of 45% potassium hydroxide to provide a pH of about 5; and
deionized water.

### EXAMPLE 15

A copper plated substrate was polished and planarized using the following polishing composition within a modified cell on a Reflection® system, available from Applied Materials, Inc. of Santa Clara, Calif.
about 12 wt. % potassium phosphate dibasic;
about 1 wt. % nitric acid;
about 1% by volume ethylenediamine;
about 2% by weight ammonium citrate tribasic;
about 0.3% by weight benzotriazole;
between about 0.5% and about 6% by volume of 85% phosphoric acid solution to provide a pH between about 5 and about 6; and
deionized water.

### EXAMPLE 16

A copper plated substrate was polished and planarized using the following polishing composition within a modified cell on a Reflection® system, available from Applied Materials, Inc. of Santa Clara, Calif.
about 15 wt. % potassium phosphate dibasic;
about 2% by weight ammonium citrate tribasic;
about 0.3% by weight benzotriazole;
between about 0.5% and about 6% by volume of 85% phosphoric acid solution to provide a pH between about 5 and about 6.5; and
deionized water.

### EXAMPLE 17

A copper plated substrate was polished and planarized using the following polishing composition within a modified cell on a Reflection® system, available from Applied Materials, Inc. of Santa Clara, Calif.
about 15 wt. % potassium phosphate dibasic;
about 2% by weight ammonium citrate tribasic;
about 0.3% by weight benzotriazole;
between about 0.5% and about 6% by volume of 45% potassium hydroxide to provide a pH of about 6; and
deionized water.

### EXAMPLE 18

A copper plated substrate was polished and planarized using the following polishing composition within a modified cell on a Reflection® system, available from Applied Materials, Inc. of Santa Clara, Calif.
about 10 wt. % of 85% phosphoric acid solution;
about 1% by volume ethylenediamine;
about 2% by weight ammonium citrate tribasic;
about 0.3% by weight benzotriazole;
between about 0.5% and about 5% by volume of 45% potassium hydroxide to provide a pH between about 5 and about 6.5; and
deionized water.

### EXAMPLE 19

A copper plated substrate was polished and planarized using the following polishing composition within a modified cell on a Reflections® system, available from Applied Materials, Inc. of Santa Clara, Calif.
about 18 wt. % phosphate tribasic;
about 1% by volume ethylenediamine;
about 2% by weight ammonium citrate tribasic;
about 0.3% by weight benzotriazole;
between about 0.5% and about 3% by volume of 45% potassium hydroxide to provide a pH of about 5; and
deionized water.

### EXAMPLE 20

A copper plated substrate was polished and planarized using the following polishing composition within a modified cell on a Reflection® system, available from Applied Materials, Inc. of Santa Clara, Calif.
about 7 wt. % of 85% phosphoric acid solution;
about 2 wt. % nitric acid;
about 1% by volume ethylenediamine;
about 2% by weight ammonium citrate tribasic;
about 0.3% by weight benzotriazole;
between about 0.5% and about 5% by volume of 45% potassium hydroxide to provide a pH between about 5 and about 6.5; and
deionized water.

### EXAMPLE 21

A copper plated substrate was polished and planarized using the following polishing composition within a modified cell on a Reflection® system, available from Applied Materials, Inc. of Santa Clara, Calif.
about 10 wt. % of 85% phosphoric acid solution;
about 2% by weight ammonium citrate tribasic;
about 0.3% by weight benzotriazole;
between about 0.5% and about 3% by volume of 45% potassium hydroxide to provide a pH of about 5; and
deionized water.

### EXAMPLE 22

A copper plated substrate was polished and planarized using the following polishing composition within a modified cell on a Reflection® system, available from Applied Materials, Inc. of Santa Clara, Calif.
about 7 wt. % potassium phosphate tribasic;
about 1% by volume ethylenediamine;
about 2% by weight ammonium citrate tribasic;
about 0.3% by weight benzotriazole;
between about 0.5% and about 3% by volume of 45% potassium hydroxide to provide a pH of about 5; and
deionized water.

### EXAMPLE 23

A copper plated substrate was polished and planarized using the following polishing composition within a modified cell on a Reflection® system, available from Applied Materials, Inc. of Santa Clara, Calif.
about 10 wt. % of 85% phosphoric acid solution;
about 2% by weight ammonium citrate tribasic;
about 0.3% by weight benzotriazole;
about 0.2 wt. % of colloidal silica (30% silica colloidal suspension)
about 0.015 vol % polyethylene imine with a molecular weight of 750000
between about 0.5% and about 7% by volume of 45% potassium hydroxide to provide a pH between about 5 and about 6.5; and
deionized water.

### EXAMPLE 24

A copper plated substrate was polished and planarized using the following polishing composition within a modified cell on a Reflections® system, available from Applied Materials, Inc. of Santa Clara, Calif.
about 18 wt. % potassium phosphate tribasic;
about 2% by weight ammonium citrate tribasic;
about 0.3% by weight benzotriazole;
between about 0.5% and about 3% by volume of 45% potassium hydroxide to provide a pH of about 5; and
deionized water.

While the foregoing is directed to embodiments of the present invention, other and further embodiments of the invention may be devised without departing from the basic scope thereof, and the scope thereof is determined by the claims that follow.

What is claimed is:

1. A composition for removing at least a conductive material from a substrate surface, comprising:
an acid based electrolyte system;
a corrosion inhibitors having an azole group;
an organic acid salt;
a pH adjusting agents to provide a pH between about 2 and about 10; and
a solvent.

2. The composition of claim 1, wherein the acid based electrolyte system is selected from the group consisting of potassium phosphate monobasic, potassium phosphate dibasic, potassium phosphate tribasic, ammonium phosphate monobasic, ammonium phosphate dibasic, and combinations thereof.

3. The composition of claim 1, wherein the corrosion inhibitor are selected from the group consisting of benzotriazole, imidazole, benzimidazole, triazole, and derivatives of benzotriazole, imidazole, benzimidazole, triazole, with hydroxy, amino, imino, carboxy, mercapto, nitro and alkyl substituted groups, and combinations thereof.

4. The composition of claim 1, wherein the organic acid salts comprises ammonium salts of organic acids, potassium salts of organic acids, or combinations thereof.

5. The composition of claim 4, wherein the organic acid salts are selected from the group of ammonium oxalate, ammonium citrate monobasic, ammonium citrate dibasic, ammonium citrate tribasic, ammonium succinate, monobasic potassium citrate, dibasic potassium citrate, tribasic potassium citrate, potassium tartarate, ammonium tartarate, potassium succinate, potassium oxalate, and combinations thereof

6. The composition of claim 1, wherein the pH adjusting agent is selected from the group consisting of an inorganic acid, a base selected from the group of potassium hydroxide, ammonium hydroxide, and combinations thereof, or combinations thereof.

7. The composition of claim 1, wherein the composition comprises:
between about 1 wt. % and about 20 wt. % of the acid based electrolyte system;
between about 0.05 wt. % and about 0.6 wt. % of the corrosion inhibitors having an azole group;
between about 0.2 wt. % and about 6 wt. % of the organic acid salt;
between about 0.5 vol. % and about 6 vol. % of the pH adjusting agents to provide a pH between about 4 and less than about 7; and
a solvent.

8. The composition of claim 1, wherein the composition comprises:
between about 4 wt. % and about 15 wt. % of the acid based electrolyte system;
between about 0.1 wt. % and about 0.4 wt. % of the corrosion inhibitors having an azole group;
between about 0.4 wt. % and about 3 wt. % of the organic acid salt;
between about 0.5 vol. % and about 6 vol. % of the pH adjusting agents to provide a pH between about 5 and about 6.5; and
a solvent.

9. The composition of claim 1, wherein the composition comprises:
between about 8 wt. % and about 12 wt. % of the acid based electrolyte system;
between about 0.2 wt. % and about 0.3 wt. % of the corrosion inhibitors having an azole group;
between about 1 wt. % and about 3 wt. % of the organic acid salt;
between about 0.5 vol. % and about 3 vol. % of the pH adjusting agents to provide a pH between about 5 and about 6.5; and
a solvent.

10. The composition of claim 7, further comprising between about 0.05 wt. % and about 2 wt. % abrasive particles, between about 0.0001 wt. % and about 0.5 wt. % of a polymeric inhibitor, a surfactant, and combinations thereof.

11. The composition of claim 1, further comprising a chelating agent having an amine or amide functional group.

12. A method of processing a substrate, comprising:
disposing a substrate having a conductive material layer formed thereon in a process apparatus comprising a first electrode and a second electrode, wherein the substrate is in electrical contact with the second electrode;
providing a polishing composition between the first electrode and the substrate, wherein the polishing composition comprises:
an acid based electrolyte system;
a corrosion inhibitor having an azole group;
an organic acid salt;
a pH adjusting agent to provide a pH between about 2 and about 10; and
a solvent;
applying a pressure between the substrate and a article by use of a polishing head;
providing relative motion between the substrate and the article by mechanical means;
applying a bias between the first electrode and the second electrode; and
removing conductive material from the conductive material layer.

13. The method of claim 12, wherein the applying the pressure comprises contacting the substrate and the polishing article at a pressure between about 0.1 and 1 psi, and the applying the bias comprises applying a current density between about 0.01 milliamps/cm² and about 100 milliamps/cm².

14. The method of claim 12, wherein the acid based electrolyte system is selected from the group of potassium phosphate monobasic, potassium phosphate dibasic, potassium phosphate tribasic, ammonium phosphate monobasic, ammonium phosphate monobasic, and combinations thereof.

15. The method of claim 12, wherein the corrosion inhibitor are selected from the group consisting of benzotriazole, imidazole, benzimidazole, triazole, and derivatives of benzotriazole, imidazole, benzimidazole, triazole, with hydroxy, amino, imino, carboxy, mercapto, nitro and alkyl substituted groups, and combinations thereof.

16. The method of claim 12, wherein the organic acid salts comprises ammonium salts of organic acids, potassium salts of organic acids, or combinations thereof.

17. The method claim 16, wherein the organic acid salts are selected from the group of ammonium oxalate, ammonium citrate monobasic, ammonium citrate dibasic, ammonium citrate tribasic, ammonium succinate, monobasic potassium citrate, dibasic potassium citrate, tribasic potassium citrate, potassium tartarate, ammonium tartarate, potassium succinate, potassium oxalate, and combinations thereof

18. The method of claim 12, wherein the pH adjusting agent are selected from the group consisting of an inorganic acid, a base selected from the group of potassium hydroxide, ammonium hydroxide, and combinations thereof, or combinations thereof.

19. The method of claim 12, wherein the composition comprises:
between about 1 wt. % and about 20 wt. % of the acid based electrolyte system;
between about 0.05 wt. % and about 0.6 wt. % of the corrosion inhibitors having an azole group;
between about 0.2 wt. % and about 6 wt. % of the organic acid salt;
between about 0.5 vol. % and about 6 vol. % of the pH adjusting agents to provide a pH between about 4 and less than about 7; and
a solvent.

20. The method of claim 12, wherein the composition comprises:
between about 4 wt. % and about 15 wt. % of the acid based electrolyte system;
between about 0.1 wt. % and about 0.4 wt. % of the corrosion inhibitors having an azole group;
between about 0.4 wt. % and about 3 wt. % of the organic acid salt;
between about 0.5 vol. % and about 6 vol. % of the pH adjusting agents to provide a pH between about 5 and about 6.5; and
a solvent.

21. The method of claim 12, wherein the composition comprises:
between about 8 wt. % and about 12 wt. % of the acid based electrolyte system;
between about 0.2 wt. % and about 0.3 wt. % of the corrosion inhibitors having an azole group;
between about 1 wt. % and about 3 wt. % of the organic acid salt;
between about 0.5 vol. % and about 3 vol. % of the pH adjusting agents to provide a pH between about 5 and about 6.5; and
a solvent.

22. The method of claim 12, further comprising between about 0.05 wt. % and about 2 wt. % abrasive particles, between about 0.001 wt. % and about 0.5 wt. % of a polymeric inhibitor, a surfactant, and combinations thereof.

23. The method of claim 12, further comprising a chelating agent having an amine or amide functional group.
